(19) United States
(12) Patent Application Publication
(10) Pub. No.: US 2025/0148592 A1
(43) Pub. Date: May 8, 2025

(54) MEDICAL SUPPORT DEVICE, MEDICAL SUPPORT SYSTEM, OPERATION METHOD OF MEDICAL SUPPORT DEVICE, AND PROGRAM

(71) Applicant: FUJIFILM CORPORATION, Tokyo (JP)

(72) Inventor: Toshihiro USUDA, Kanagawa (JP)

(21) Appl. No.: 18/915,365

(22) Filed: Oct. 15, 2024

(30) Foreign Application Priority Data
Nov. 2, 2023 (JP) 2023-188923

(51) Int. Cl. G06T 7/00

(52) U.S. Cl. CPC G06T 7/0012; G06T 2207/20084

(57) ABSTRACT

A medical support device includes a processor and communicates with an external device that transmits medical information including a medical image and/or modality-related information. The medical image is obtained by imaging a subject via a modality. The modality-related information is information on the modality at a timing at which the medical image is obtained. The processor receives the medical information transmitted from the external device, executes first processing on the medical information, transmits an execution result, switches a processing content of the first processing in accordance with the medical information, and transmits switching content information indicating a switching content.

### CROSS-REFERENCE TO RELATED APPLICATIONS

This application claims priority under 35 USC 119 from Japanese Patent Application No. 2023-188923, filed on Nov. 2, 2023, the disclosure of which is incorporated by reference herein.

### BACKGROUND

### 1. Technical Field

The present disclosure relates to a medical support device, a medical support system, an operation method of a medical support device, and a program.

### 2. Related Art

JP2023-526412A discloses an information processing method including receiving first information associated with an operation of a medical examination device and outputting at least a part of the first information, in which the first information is associated with data collection executed by the medical examination device during the operation. In the information processing method disclosed in JP2023-526412A, receiving the first information includes receiving the first information from a cloud storage device, in which the first information is transmitted from a data analysis device of the medical examination device to the cloud storage device, and the first information is determined based on input data of the medical examination device.

JP2021-039748A discloses an information processing device comprising an estimation unit that estimates a risk of a subject developing a disease by using a trained model that has learned a relationship between a feature value acquired from a fundus image, biological information acquired by an examination device, and the risk of the subject developing the disease, and a display controller that displays the estimated risk of developing the disease on a display unit. In the information processing device disclosed in JP2021-039748A, an instruction from an examiner regarding the estimation of the risk of developing the disease is information obtained by using at least one of a trained model for character recognition, a trained model for voice recognition, or a trained model for gesture recognition.

JP2020-078539A discloses a diagnosis support method for a disease based on an endoscopic image of a digestive organ using a convolutional neural network. In the diagnosis support method disclosed in JP2020-078539A, the convolutional neural network is trained using a first endoscopic image of the digestive organ and at least one definitive diagnosis result, corresponding to the first endoscopic image, of positivity or negativity of a disease of the digestive organ, a past disease, a level of severity, a depth of the disease, or information corresponding to an imaged part. The trained convolutional neural network outputs at least one of a probability of positivity and/or negativity of the disease of the digestive organ, a probability of the past disease, the level of severity of the disease, the depth of the disease, or a probability corresponding to the imaged part, based on a second endoscopic image of the digestive organ.

### SUMMARY

One embodiment according to the present disclosure provides a medical support device, a medical support system, an operation method of a medical support device, and a program that can allow a user or the like to whom an execution result obtained by execution of first processing via the medical support device is provided from the medical support device, to understand a switching content in a case in which a processing content of the first processing is switched.

A first aspect according to the present disclosure relates to a medical support device comprising: a processor, in which the medical support device communicates with an external device that transmits medical information including a medical image and/or modality-related information, the medical image is obtained by imaging a subject via a modality, the modality-related information is information on the modality at a timing at which the medical image is obtained, and the processor receives the medical information transmitted from the external device, executes first processing on the medical information, transmits an execution result obtained by executing the first processing, switches a processing content of the first processing in accordance with the medical information, and transmits switching content information indicating a switching content in a case in which the processing content is switched.

A second aspect according to the present disclosure relates to the medical support device according to the first aspect, in which the first processing includes AI processing of generating related information related to the medical information by inputting the medical information to a trained model that receives input of first information corresponding to the medical information to generate second information corresponding to the related information.

A third aspect according to the present disclosure relates to the medical support device according to the second aspect, in which the switching content information in a case in which a processing content of the AI processing is switched includes AI processing switching content information indicating a content in which the processing content of the AI processing is switched.

A fourth aspect according to the present disclosure relates to the medical support device according to the third aspect, in which a plurality of types of the trained models are present, the trained model as an input destination for the medical information is switched in accordance with the medical information in the AI processing, and the AI processing switching content information in a case in which the trained model is switched includes model switching content information indicating a content in which the trained model is switched.

A fifth aspect according to the present disclosure relates to the medical support device according to the fourth aspect, in which the model switching content information includes trained model specification information for specifying the trained model used to obtain the execution result transmitted by the processor.

A sixth aspect according to the present disclosure relates to the medical support device according to the fourth or fifth aspect, in which the medical information includes the modality-related information, and the trained model as the input destination for the medical information is switched in accordance with the modality-related information in the AI processing.

A seventh aspect according to the present disclosure relates to the medical support device according to the sixth aspect, in which the medical information includes the medical image, and the trained model as the input destination for the medical image is switched in accordance with the modality-related information in the AI processing.

An eighth aspect according to the present disclosure relates to the medical support device according to any one of the fourth to seventh aspects, in which the medical information includes the medical image and the modality-related information, the modality-related information includes light source specification information for specifying a light source used for imaging to obtain the medical image, and the trained model as the input destination for the medical image is switched in accordance with the light source specification information in the AI processing.

A ninth aspect according to the present disclosure relates to the medical support device according to any one of the fourth to eighth aspects, in which the medical information includes the medical image and the modality-related information, the modality-related information includes variable magnification specification information for specifying variable magnification applied to the medical image, and the trained model as the input destination for the medical image is switched in accordance with the variable magnification specification information in the AI processing.

A tenth aspect according to the present disclosure relates to the medical support device according to any one of the fourth to ninth aspects, in which the medical information includes the modality-related information, the modality-related information includes modality specification information for specifying the modality, and the trained model as the input destination for the medical information is switched in accordance with the modality specification information in the AI processing.

An eleventh aspect according to the present disclosure relates to the medical support device according to the tenth aspect, in which the medical information includes the medical image, and the trained model as the input destination for the medical image is switched in accordance with the modality specification information in the AI processing.

A twelfth aspect according to the present disclosure relates to the medical support device according to any one of the second to eleventh aspects, in which the medical information includes the medical image and the modality-related information, the modality-related information includes image quality information that is information on an image quality of the medical image, and a processing content of the AI processing is switched in accordance with the image quality information.

A thirteenth aspect according to the present disclosure relates to the medical support device according to the twelfth aspect, in which the image quality information includes a parameter for defining the image quality and/or image mode specification information for specifying an image mode applied to the modality to obtain the medical image.

A fourteenth aspect according to the present disclosure relates to the medical support device according to any one of the second to thirteenth aspects, in which the medical information includes the medical image, the first information is a first image corresponding to the medical image, the second information is information for specifying a first region corresponding to a feature region shown in the medical image, and the trained model receives input of the medical image to generate feature region specification information for specifying the feature region as the related information.

A fifteenth aspect according to the present disclosure relates to the medical support device according to any one of the first to fourteenth aspects, in which the modality is an endoscope device, and the medical image is an endoscopic image obtained by imaging an inside of a body of the subject via the endoscope device.

A sixteenth aspect according to the present disclosure relates to a medical support system comprising: the medical support device according to any one of the first to fifteenth aspects; and the external device.

A seventeenth aspect according to the present disclosure relates to the medical support system according to the sixteenth aspect, in which the external device transmits the medical information to the medical support device on a condition that a change has occurred in the medical information.

An eighteenth aspect according to the present disclosure relates to the medical support system according to the sixteenth aspect, in which the external device transmits a part included in the medical information to the medical support device on a condition that a change has occurred in the part.

A nineteenth aspect according to the present disclosure relates to an operation method of a medical support device that communicates with an external device that transmits medical information including a medical image and/or modality-related information, in which the medical image is obtained by imaging a subject via a modality, the modality-related information is information on the modality at a timing at which the medical image is obtained, and the operation method comprises: receiving the medical information transmitted from the external device; executing first processing on the medical information; transmitting an execution result obtained by executing the first processing; switching a processing content of the first processing in accordance with the medical information; and transmitting switching content information indicating a switching content in a case in which the processing content is switched.

A twentieth aspect according to the present disclosure relates to a program causing a computer applied to a medical support device that communicates with an external device that transmits medical information including a medical image and/or modality-related information, to execute a medical support process, in which the medical image is obtained by imaging a subject via a modality, the modality-related information is information on the modality at a timing at which the medical image is obtained, and the medical support process comprises: executing first processing on the medical information; transmitting an execution result obtained by executing the first processing; switching a processing content of the first processing in accordance with the medical information; and transmitting switching content information indicating a switching content in a case in which the processing content is switched.

### BRIEF DESCRIPTION OF THE DRAWINGS

Exemplary embodiments of the technology of the disclosure will be described in detail based on the following figures, wherein:

FIG. 1 is a conceptual diagram showing an example of an aspect in which a medical support system is used by a doctor;

FIG. 2 is a conceptual diagram showing an example of an overall configuration of the medical support system;

FIG. 3 is a block diagram showing an example of a hardware configuration of an electric system of the medical support system;

FIG. 4 is a block diagram showing an example of main functions of a processor included in a server and an example of information stored in a storage;

FIG. 5 is a conceptual diagram showing an example of processing contents executed by the server and an endoscope device;

FIG. 6 is a conceptual diagram showing an example of the processing contents executed by the server and the endoscope device;

FIG. 7 is a flowchart showing an example of a flow of a medical support process;

FIG. 8 is a first modification example of the configuration shown in FIG. 5;

FIG. 9 is a first modification example of the configuration shown in FIG. 6;

FIG. 10 is a second modification example of the configuration shown in FIG. 5;

FIG. 11 is a diagram showing a second modification example of the configuration shown in FIG. 6;

FIG. 12 is a third modification example of the configuration shown in FIG. 5;

FIG. 13 is a third modification example of the configuration shown in FIG. 6;

FIG. 14 is a fourth modification example of the configuration shown in FIG. 5;

FIG. 15 is a fourth modification example of the configuration shown in FIG. 6;

FIG. 16 is a fifth modification example of the configuration shown in FIG. 5;

FIG. 17 is a fifth modification example of the configuration shown in FIG. 6;

FIG. 18 is a sixth modification example of the configuration shown in FIG. 5;

FIG. 19 is a sixth modification example of the configuration shown in FIG. 6; and

FIG. 20 is a conceptual diagram showing an example of an aspect in which medical information is transmitted from the endoscope device to the server.

### DETAILED DESCRIPTION

Hereinafter, examples of embodiments of a medical support device, a medical support system, an operation method of a medical support device, and a program according to the present disclosure will be described with reference to the accompanying drawings.

First, the terms used in the following description will be described.

CPU is an abbreviation for “central processing unit”. GPU is an abbreviation for “graphics processing unit”. GPGPU is an abbreviation for “general-purpose computing on graphics processing units”. APU is an abbreviation for “accelerated processing unit”. TPU is an abbreviation for “tensor processing unit”. RAM is an abbreviation for “random-access memory”. NVM is an abbreviation for “non-volatile memory”. EEPROM is an abbreviation for “electrically erasable programmable read-only memory”. ASIC is an abbreviation for “application-specific integrated circuit”. PLD is an abbreviation for “programmable logic device”. FPGA is an abbreviation for “field-programmable gate array”. SoC is an abbreviation for “system-on-a-chip”. SSD is an abbreviation for “solid-state drive”. USB is an abbreviation for “Universal Serial Bus”. HDD is an abbreviation for “hard disk drive”. EL is an abbreviation for “electro-luminescence”. CMOS is an abbreviation for “complementary metal-oxide-semiconductor”. CCD is an abbreviation for “charge-coupled device”. AI is an abbreviation for “artificial intelligence”. BLI is an abbreviation for “blue light imaging”. LCI is an abbreviation for “linked color imaging”. I/F is an abbreviation for “interface”. LAN is an abbreviation for “local area network”. WAN is an abbreviation for “wide area network”. 5G is an abbreviation for “5th generation mobile communication system”. IC is an abbreviation for “integrated circuit”. MRI is an abbreviation for “magnetic resonance imaging”. CT is an abbreviation for “computed tomography”. THI is an abbreviation for “tissue harmonic imaging”. CH is an abbreviation for “compound harmonic”. CHI is an abbreviation for “contrast harmonic imaging”.

In the following description, a processor with a reference numeral (hereinafter, simply referred to as “processor”) may be one physical or virtual operation device or a combination of a plurality of physical or virtual operation devices. Further, the processor may be one type of operation device or a combination of a plurality of types of operation devices. Examples of the operation device include a CPU, a GPU, a GPGPU, an APU, and a TPU.

In the following description, a memory with a reference numeral is a memory such as a RAM that temporarily stores information, and is used as a work memory by the processor.

In the following description, a storage with a reference numeral is one or more non-volatile storage devices that store various programs, various parameters, and the like. Examples of the non-volatile storage device include a flash memory, a magnetic disk, and a magnetic tape. Examples of the storage also include a cloud storage.

In the following embodiment, an external I/F with a reference numeral controls the transmission and the reception of various types of information among a plurality of devices connected to each other. Examples of the external I/F include a USB interface. A communication I/F including a communication processor, an antenna, and the like may be applied to the external I/F. The communication I/F controls communication among a plurality of computers. Examples of a communication standard applied to the communication I/F include a wireless communication standard including 5G, Wi-Fi (registered trademark), or Bluetooth (registered trademark).

In the following embodiment, “A and/or B” is synonymous with “at least one of A or B” That is, “A and/or B” may mean only A, only B, or a combination of A and B. In the present specification, the same concept as “A and/or B” also applies to a case in which three or more matters are expressed by association with “and/or”.

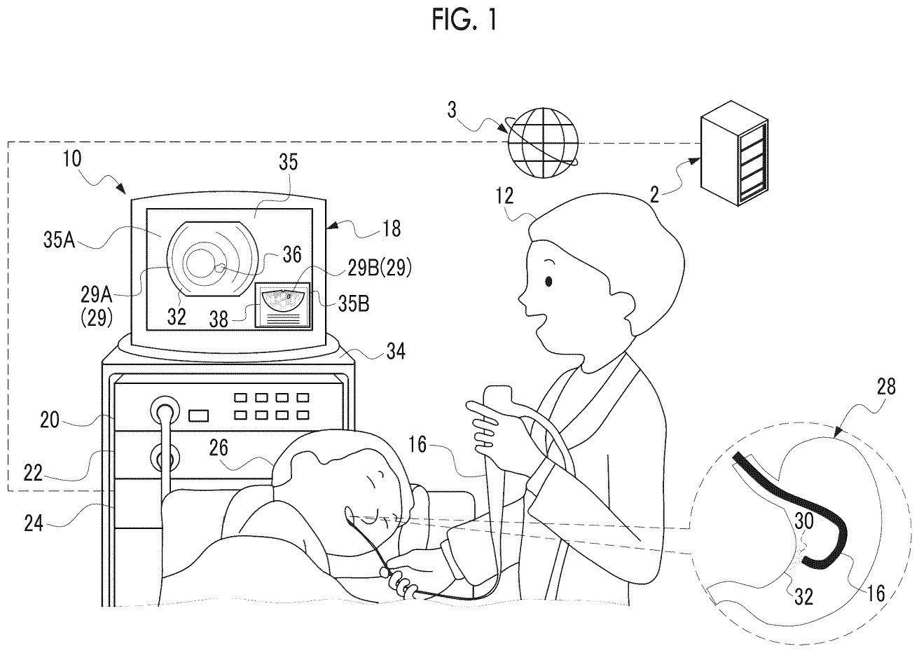

FIG. 1 is a conceptual diagram showing an example of an aspect in which a medical support system 1 is used. As shown in FIG. 1, the medical support system 1 comprises a server 2 and an endoscope device 10, and the server 2 and the endoscope device 10 are connected to each other via a network 3 so as to be able to communicate with each other. Examples of the network 3 include the Internet. However, the Internet is merely an example, and examples of the network 3 also include a WAN and/or a LAN. In the present embodiment, the medical support system 1 is an example of a “medical support system” according to the present disclosure, the server 2 is an example of a “medical support device” according to the present disclosure, and the endoscope device 10 is an example of a “modality”, an “external device”, and an “endoscope device” according to the present disclosure.

The endoscope device 10 is used by a doctor 12 in an endoscopy and the like. The endoscopy is assisted by a staff member such as a nurse. In the present embodiment, the doctor 12 is a user of the endoscope device 10 and also a user of the medical support system 1.

The endoscope device 10 comprises an endoscope body 16, a display device 18, a light source device 20, a control device 22, and a function expansion device 24. The endoscope device 10 is a modality for performing a medical treatment on an inside of a body of a subject 26 (for example, a patient) by using the endoscope body 16. The medical treatment includes observation, treatment, and the like. In the present embodiment, an upper gastrointestinal tract 28 (for example, an esophagus, a stomach, and a duodenum) that is a lumen organ of the subject 26 is a target on which the medical treatment is performed by the doctor 12. In the present embodiment, the subject 26 is an example of a “subject” according to the present disclosure.

In the endoscope device 10, the inside of the body of the subject 26 is imaged by the endoscope body 16. In the present embodiment, the imaging refers to processing of detecting physical energy (for example, reflected light or a reflected wave of ultrasound) and converting the detection results into images.

In the present embodiment, as an example of the endoscope device 10, a hybrid-type endoscope device of an optical-type upper endoscope device and an ultrasound-type upper endoscope device (that is, an endoscope device in which the optical-type upper endoscope device and the ultrasound-type upper endoscope device are combined) is used. The optical-type upper endoscope device refers to, for example, an endoscope device that images reflected light obtained by emitting light 30 inside the upper gastrointestinal tract 28 via the endoscope body 16 inserted into the upper gastrointestinal tract 28 and reflecting the light 30 from an interior wall 32 of the upper gastrointestinal tract 28. In addition, the ultrasound-type upper endoscope device refers to, for example, an endoscope device that generates an image based on a reflected wave obtained by emitting ultrasound inside the upper gastrointestinal tract 28 via the endoscope body 16 inserted into the upper gastrointestinal tract 28.

Here, for convenience of description, the upper endoscope device used for an upper endoscopy is described as an example, but this is merely an example, and the present disclosure is also applicable to a lower endoscope device used for a lower endoscopy. In addition, the present disclosure is also applicable to an endoscope device used for an endoscopy of an organ other than a digestive organ (for example, a bronchoscope device, an otorhinolaryngological endoscope device, an intracranial endoscope device, or a laparoscope).

Information obtained by the endoscope device 10 is transmitted to the server 2 via the network 3. Examples of the server 2 include a cloud server. The cloud server is merely an example, and the server 2 may be an on-premises server. The server 2 receives the information transmitted from the endoscope device 10, executes processing using the received information, and transmits a processing result obtained by executing the processing to the endoscope device 10.

The endoscope body 16 is inserted into the upper gastrointestinal tract 28 by being operated by the doctor 12. The endoscope device 10 images an inside of the upper gastrointestinal tract 28 of the subject 26 via the endoscope body 16 inserted into the upper gastrointestinal tract 28 of the subject 26, and generates a medical image 29 showing an aspect inside the body of the subject 26. In the present embodiment, the medical image 29 is an example of a “medical image” and an “endoscopic image” according to the present disclosure.

In the present embodiment, an optical image 29A and an ultrasound image 29B are included in the concept of the medical image 29. The endoscope device 10 generates the optical image 29A by imaging the reflected light obtained by emitting the light 30 inside the upper gastrointestinal tract 28 via the endoscope body 16 inserted into the upper gastrointestinal tract 28 and reflecting the light 30 from the interior wall 32 of the upper gastrointestinal tract 28. In addition, the endoscope device 10 generates the ultrasound image 29B based on the reflected wave obtained by emitting the ultrasound inside the upper gastrointestinal tract 28 via the endoscope body 16 inserted into the upper gastrointestinal tract 28 and reflecting the ultrasound inside the body of the subject 26. The doctor 12 performs the medical treatment on the upper gastrointestinal tract 28 based on the medical image 29 obtained by being captured by the endoscope body 16.

It should be noted that, in the present embodiment, the endoscopy on the upper gastrointestinal tract 28 is described as an example, but this is merely an example, and the present disclosure is applicable even in a case of an endoscopy on a lumen organ such as a large intestine or a trachea.

The light source device 20, the control device 22, and the function expansion device 24 are installed on a wagon 34. The wagon 34 is provided with a plurality of stages along an up-down direction, and the function expansion device 24, the control device 22, and the light source device 20 are installed from a lower stage to an upper stage. In addition, the display device 18 is installed on the uppermost stage in the wagon 34.

The control device 22 controls the entire endoscope device 10. The function expansion device 24 executes various types of processing on the information obtained from the control device 22 and the information obtained from the server 2 (for example, an image obtained by imaging the interior wall 32 via the endoscope body 16, and the processing result of the server 2). In addition, the function expansion device 24 is connected to the server 2 via the network 3 so as to be able to communicate with each other and requests the provision of the service from the server 2 to receive the provision of the requested service from the server 2.

The display device 18 displays various types of information including the image. Examples of the display device 18 include a liquid-crystal display and an EL display. In addition, a tablet terminal with a display may be used instead of or together with the display device 18.

A screen 35 is displayed on the display device 18. The screen 35 includes a plurality of display regions. In the example shown in FIG. 1, a first display region 35A and a second display region 35B are shown as examples of the plurality of display regions. A size of the first display region 35A is larger than a size of the second display region 35B. The first display region 35A is used as a main display region, and the second display region 35B is used as a sub-display region. A size relationship between the first display region 35A and the second display region 35B is not limited thereto, and need only be a size relationship that fits on the screen 35.

The medical image 29 is displayed in the first display region 35A. For example, the optical image 29A and the ultrasound image 29B are selectively displayed in the first display region 35A. In the example shown in FIG. 1, the optical image 29A is displayed in the first display region 35A. The medical image 29 displayed in the first display region 35A is a moving image. The example shown in FIG. 1 shows, as an example of the optical image 29A displayed in the first display region 35A, a moving image in which the interior wall 32 is shown.

The interior wall 32 shown in the optical image 29A displayed in the first display region 35A includes a lesion 36 (for example, one lesion 36 in the example shown in FIG. 1) as a region of interest (that is, an observation target region) focused on by the doctor 12, and the doctor 12 can visually recognize an aspect of the interior wall 32 including the lesion 36 through the optical image 29A. In the present embodiment, the lesion 36 is an example of a “feature region” according to the present disclosure.

There are various types of the lesion 36, and examples of the types of the lesion 36 include a gastric ulcer and a gastric cancer. It should be noted that the types shown here are types assumed in advance as the type of the lesion 36 in a case in which the endoscopy is performed on the upper gastrointestinal tract 28, and the types of the lesion 36 may be different depending on the organ on which the endoscopy is performed. In a case in which the organ on which the endoscopy is performed is a large intestine, examples of the type of the lesion 36 include a neoplastic polyp and a non-neoplastic polyp. Examples of the type of the neoplastic polyp include an adenomatous polyp (for example, SSL). Examples of the type of the non-neoplastic polyp include a hamartomatous polyp, a hyperplastic polyp, and an inflammatory polyp.

In the present embodiment, for convenience of description, the form example is described in which one lesion 36 is shown in the optical image 29A, but the present disclosure is not limited thereto, and the present disclosure is applicable even in a case in which a plurality of lesions 36 are shown in the optical image 29A.

In the present embodiment, the lesion 36 is shown, but this is merely an example, and the region of interest (that is, the observation target region) focused on by the doctor 12 may be a feature region having some unique feature, such as an organ (for example, a duodenal papilla), a mark, an artificial treatment tool (for example, an artificial clip), a treated region (for example, a region in which a trace of removal of a polyp or the like remains), or the like.

The medical image 29 (in the example shown in FIG. 1, the optical image 29A) displayed in the first display region 35A is one frame included in the moving image including a plurality of frames in time series. That is, the plurality of frames in time series are displayed in the first display region 35A at a predetermined frame rate (for example, several tens of frames/second).

Examples of the moving image displayed in the first display region 35A include a moving image of a live-view method. The live-view method is merely an example, and a moving image which is temporarily stored in a memory or the like and then displayed, such as a moving image of a post-view method, may be used. In addition, each frame included in a recorded moving image stored in a memory or the like may be reproduced and displayed on the screen 35 (for example, the first display region 35A) as the moving image.

The second display region 35B is displayed at the lower right in the screen 35 in front view. The display position of the second display region 35B may be any position as long as the display position is within the screen 35 of the display device 18, but it is preferable that the second display region 35B is displayed at a position comparable to the medical image 29 displayed in the first display region 35A.

Auxiliary information 38 is displayed in the second display region 35B. The auxiliary information 38 is information for assisting the doctor 12 in making a medical determination or the like in the endoscopy and is referred to by the doctor 12. Examples of the auxiliary information 38 include various types of information on the subject 26 into which the endoscope body 16 is inserted and/or various types of information obtained by executing a medical support process described later. In the example shown in FIG. 1, as an example of the auxiliary information 38, information including the medical image 29 obtained in the past (for example, the ultrasound image 29B obtained in the past) is shown.

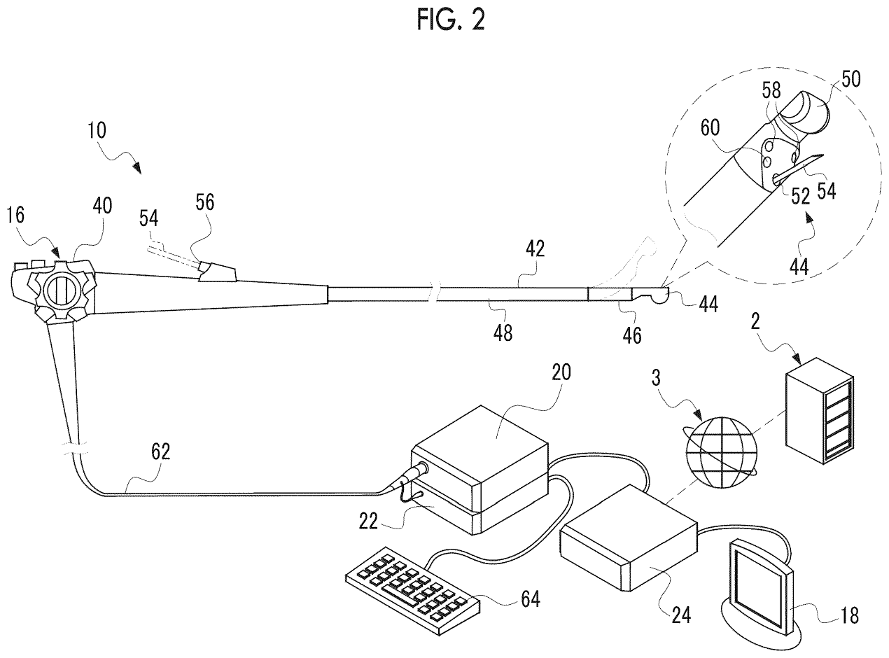

FIG. 2 is a conceptual diagram showing an example of an overall configuration of the endoscope device 10. As shown in FIG. 2, the endoscope body 16 comprises an operating part 40 and an insertion part 42. The insertion part 42 is formed in a tubular shape. The insertion part 42 includes a distal end part 44, a bendable part 46, and a soft part 48. The distal end part 44, the bendable part 46, and the soft part 48 are disposed in an order of the distal end part 44, the bendable part 46, and the soft part 48 from a distal end side to a base end side of the insertion part 42. The soft part 48 is formed of a material having a long and flexible shape and connects the operating part 40 and the bendable part 46. The bendable part 46 is partially bent or rotated about an axial center of the insertion part 42 by operating the operating part 40. In this way, the insertion part 42 is fed to the inside of the upper gastrointestinal tract 28 while being bent or rotated about the axial center of the insertion part 42 in accordance with a shape of the lumen organ (for example, a shape of a pathway of the upper gastrointestinal tract 28).

The distal end part 44 is provided with an ultrasound probe 50 and a treatment tool opening 52. The ultrasound probe 50 is provided on a distal end side of the distal end part 44. The ultrasound probe 50 is a convex-type ultrasound probe that emits the ultrasound to receive the reflected wave obtained by reflecting the emitted ultrasound from the emission target region (for example, an organ such as a pancreas). Here, the convex-type ultrasound probe is described as an example of the ultrasound probe 50, but this is merely an example, and, for example, a radial type ultrasound probe may also be used.

The treatment tool opening 52 is formed on a base end side of the distal end part 44 with respect to the ultrasound probe 50. The treatment tool opening 52 is an opening for allowing a treatment tool 54 to protrude from the distal end part 44. A treatment tool insertion port 56 is formed at the operating part 40, and the treatment tool 54 is inserted into the insertion part 42 through the treatment tool insertion port 56. The treatment tool 54 passes through the insertion part 42 and protrudes from the treatment tool opening 52 to the outside of the endoscope body 16. In addition, the treatment tool opening 52 is also used as a suction port for suctioning blood, body waste, and the like and as a delivery port for sending out a fluid.

In the example shown in FIG. 2, a puncture needle is shown as the treatment tool 54. It should be noted that this is merely an example, and the treatment tool 54 may be a grasping forceps, a papillotomy knife, a snare, a catheter, a guide wire, a cannula, a puncture needle with a guide sheath, and the like.

In the example shown in FIG. 2, the distal end part 44 is provided with an illumination device 58 and a camera 60. The illumination device 58 emits the light 30 (see FIG. 1). Examples of the types of the light 30 emitted from the illumination device 58 include white light and special light. Examples of the special light include light for BLI and/or light for LCI.

The camera 60 is mounted in the endoscope body 16. The camera 60 is inserted into the upper gastrointestinal tract 28 of the subject 26 and images the observation target region in a state in which the light 30 is emitted inside the upper gastrointestinal tract 28 by the illumination device 58, thereby generating the optical image 29A. Examples of the camera 60 include a CMOS camera. The CMOS camera is merely an example, and another type of camera such as a CCD camera may be used. It should be noted that the image obtained by being captured by the camera 60 is displayed on the display device 18, is displayed on a display device (for example, a display of a tablet terminal) other than the display device 18, is stored in a storage medium (for example, a flash memory, an HDD, and/or a magnetic tape), or is transmitted to the server 2.

The endoscope body 16 is connected to the light source device 20 and the control device 22 via a universal cord 62. The function expansion device 24 and a reception device 64 are connected to the control device 22. The display device 18 is also connected to the function expansion device 24 along with the server 2. That is, the control device 22 is connected to the server 2 and the display device 18 via the function expansion device 24.

Here, since the function expansion device 24 is shown as an external device for expanding the function executed by the control device 22, the form example is described in which the control device 22 and the display device 18 are indirectly connected to each other via the function expansion device 24, but this is merely an example. For example, the display device 18 may be directly connected to the control device 22. In this case, for example, a function of the function expansion device 24 need only be installed in the control device 22. The reception device 64 receives an instruction from the doctor 12 and outputs the received instruction, as an electric signal, to the control device 22. Examples of the reception device 64 include a keyboard, a mouse, a touch panel, a foot switch, a microphone, and/or a remote operation device.

The control device 22 controls the light source device 20 in accordance with the instruction received by the reception device 64, executes the transmission and the reception of various signals with the endoscope body 16, or executes the transmission and the reception of various signals with the function expansion device 24.

The light source device 20 emits light under the control of the control device 22 to supply the light 30 to the illumination device 58. The illumination device 58 is provided with a built-in light guide, and the light 30 supplied from the light source device 20 is emitted from the distal end part 44 via the light guide. The control device 22 causes the camera 60 to execute the imaging in accordance with the instruction received by the reception device 64, acquires the optical image 29A (see FIG. 1) from the camera 60, and outputs the acquired optical image 29A to a predetermined output destination (for example, the function expansion device 24). In addition, the control device 22 causes the ultrasound probe 50 to emit the ultrasound in response to the instruction received by the reception device 64, generates the ultrasound image 29B (see FIG. 1) based on the reflected wave received by the ultrasound probe 50, and outputs the ultrasound image 29B to a predetermined output destination.

The function expansion device 24 is a device that expands functions of the endoscope device 10. The function expansion device 24 supports a medical act (here, as an example, the endoscopy) by executing processing using the medical image 29 input from the control device 22. The function expansion device 24 transmits various types of information including the medical image 29 to the server 2 via the network 3 or outputs the various types of information including the medical image 29 to the display device 18. Further, the function expansion device 24 receives the information transmitted from the server 2 and outputs the received information to the display device 18 or stores the received information in the storage medium.

It should be noted that, here, the form example is described in which the medical image 29 output from the control device 22 is output to the display device 18 via the function expansion device 24, but this is merely an example. For example, an aspect may be adopted in which the control device 22 and the display device 18 are connected to each other, and the medical image 29 acquired by the function expansion device 24 is displayed on the display device 18 via the control device 22.

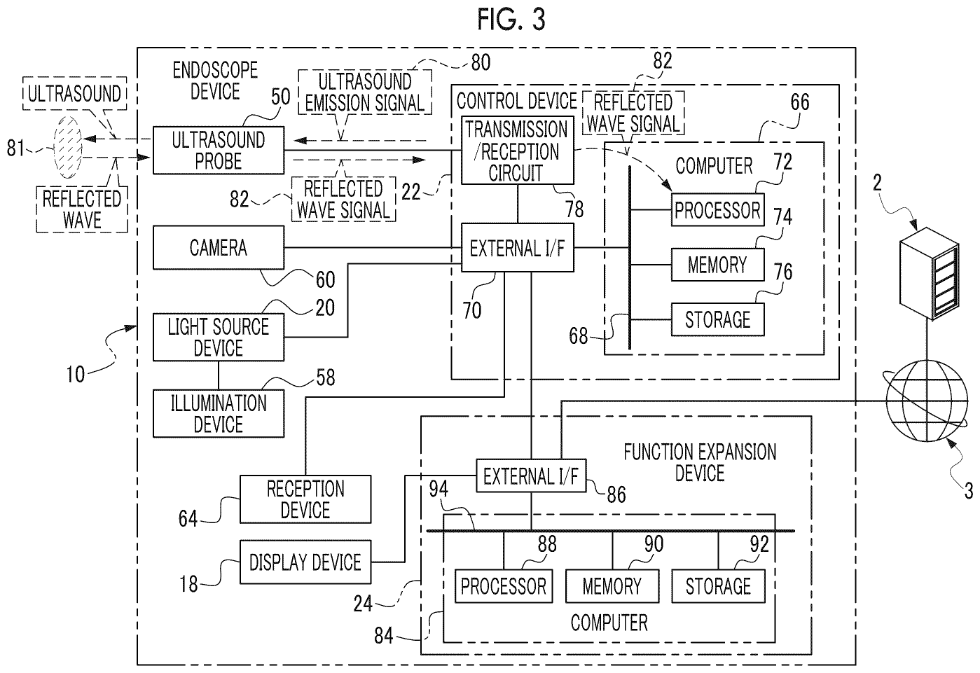

FIG. 3 is a block diagram showing an example of a hardware configuration of an electric system of the endoscope device 10. As shown in FIG. 3, the control device 22 comprises a computer 66, a bus 68, and an external I/F 70. The computer 66 comprises a processor 72, a memory 74, and a storage 76. The processor 72, the memory 74, the storage 76, and the external I/F 70 are connected to the bus 68. The processor 72 controls the entire control device 22. The memory 74 and the storage 76 are used by the processor 72.

The external I/F 70 controls the transmission and the reception of various types of information between one or more devices (hereinafter also referred to as “first external devices”) present outside the control device 22 and the processor 72.

The camera 60 is connected to the external I/F 70 as one of the first external devices, and the external I/F 70 controls the transmission and the reception of various types of information between the camera 60 and the processor 72. The processor 72 controls the camera 60 via the external I/F 70. In addition, the processor 72 acquires, via the external I/F 70, the optical image 29A (see FIG. 1) obtained by imaging the inside of the upper gastrointestinal tract 28 (see FIG. 1) via the camera 60.

The light source device 20 is connected to the external I/F 70 as one of the first external devices, and the external I/F 70 controls the transmission and the reception of various types of information between the light source device 20 and the processor 72. The light source device 20 supplies the light to the illumination device 58 under the control of the processor 72. The illumination device 58 emits the light supplied from the light source device 20.

The reception device 64 is connected to the external I/F 70 as one of the first external devices, and the processor 72 acquires the instruction received by the reception device 64 via the external I/F 70 and executes processing in accordance with the acquired instruction.

A transmission/reception circuit 78 is connected to the external I/F 70. The transmission/reception circuit 78 generates an ultrasound emission signal 80 having a pulse waveform to output the ultrasound emission signal 80 to the ultrasound probe 50 in accordance with an instruction from the processor 72. The ultrasound probe 50 converts the ultrasound emission signal 80 input from the transmission/reception circuit 78 into the ultrasound and emits the ultrasound to an emission target region 81 (for example, an organ such as a prostate). The ultrasound probe 50 receives the reflected wave obtained by reflecting the ultrasound wave emitted from the ultrasound probe 50 from the emission target region 81, converts the reflected wave into a reflected wave signal 82, which is the electric signal, and outputs the reflected wave signal 82 to the transmission/reception circuit 78. The transmission/reception circuit 78 digitizes the reflected wave signal 82 input from the ultrasound probe 50 and outputs the digitized reflected wave signal 82 to the processor 72 via the external I/F 70. The processor 72 generates the ultrasound image 29B (see FIG. 1) showing an aspect of the emission target region 81 based on the reflected wave signal 82 input from the transmission/reception circuit 78 via the external I/F 70.

The function expansion device 24 comprises a computer 84 and an external I/F 86. The computer 84 comprises a processor 88, a memory 90, and a storage 92. The processor 88, the memory 90, the storage 92, and the external I/F 86 are connected to a bus 94. It should be noted that, since a hardware configuration (that is, the processor 88, the memory 90, and the storage 92) of the computer 84 is basically the same as the hardware configuration of the computer 66, the description of the hardware configuration of the computer 84 will be omitted here.

The external I/F 86 controls the transmission and the reception of various types of information between one or more devices (hereinafter also referred to as “second external devices”) present outside the function expansion device 24 and the processor 88.

The control device 22 is connected to the external I/F 86 as one of the second external devices. In the example shown in FIG. 3, the external I/F 70 of the control device 22 is connected to the external I/F 86. The external I/F 86 controls the transmission and the reception of various types of information between the processor 88 of the function expansion device 24 and the processor 72 of the control device 22. For example, the processor 88 acquires the medical image 29 (see FIG. 1) from the processor 72 of the control device 22 via the external I/F 70 and the external I/F 86. Then, the processor 88 executes processing using the medical image 29.

The display device 18 is connected to the external I/F 86 as one of the second external devices. The processor 88 displays various types of information (for example, the medical image 29) on the display device 18 by controlling the display device 18 via the external I/F 86. For example, the processor 88 displays the medical image 29 on the screen 35 (for example, the first display region 35A) of the display device 18.

The server 2 is connected to the external I/F 86 as one of the second external devices via the network 3. The processor 88 executes the transmission and the reception of various types of information with the server 2 via the external I/F 86. For example, the external I/F 86 transmits the medical image 29 acquired by the processor 88 to the server 2. The server 2 receives the medical image 29 transmitted from the external I/F 86, executes processing using the received medical image 29, and transmits a processing result to the function expansion device 24. The external I/F 86 receives the processing result transmitted from the server 2.

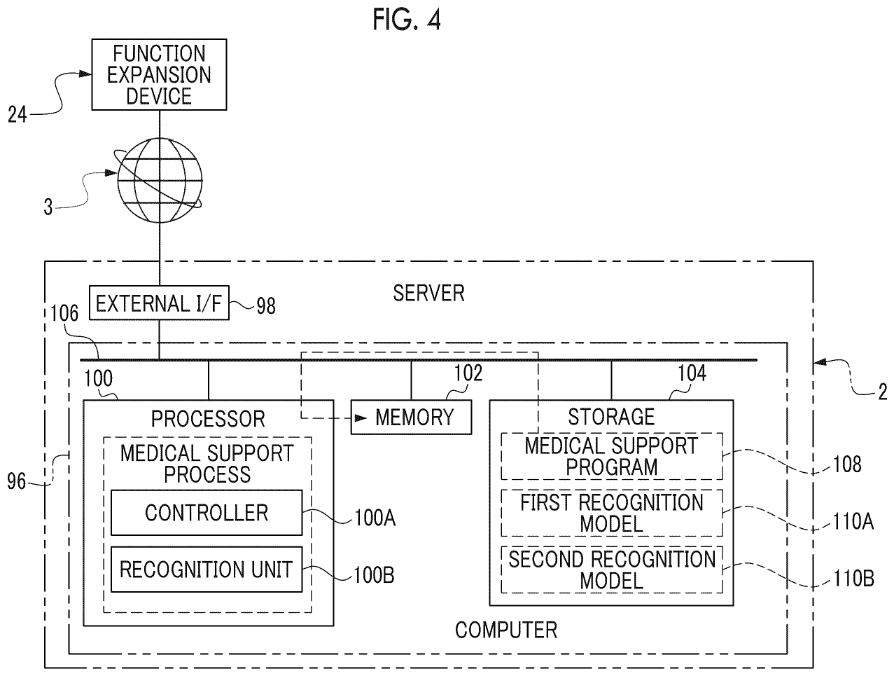

FIG. 4 is a block diagram showing an example of a hardware configuration of an electric system of the server 2. As shown in FIG. 4, the server 2 comprises a computer 96 and an external I/F 98. The computer 96 comprises a processor 100, a memory 102, and a storage 104. The processor 100, the memory 102, the storage 104, and the external I/F 98 are connected to a bus 106. In the present embodiment, the computer 96 is an example of a “computer” according to the present disclosure, and the processor 100 is an example of a “processor” according to the present disclosure. It should be noted that, since a hardware configuration (that is, the processor 100, the memory 102, and the storage 104) of the computer 96 is basically the same as the hardware configuration of the computer 66, the description of the hardware configuration of the computer 96 will be omitted here.

The external I/F 98 controls the transmission and the reception of various types of information between one or more devices (hereinafter also referred to as “third external devices”) present outside the server 2 and the processor 100. The function expansion device 24 is connected to the external I/F 98 as one of the third external devices via the network 3. The processor 100 executes the transmission and the reception of various types of information with the function expansion device 24 via the external I/F 98. For example, the external I/F 98 receives various types of information such as the medical image 29 transmitted from the function expansion device 24. The processor 100 executes processing using the information received by the external I/F 98 and transmits a processing result to the function expansion device 24.

Meanwhile, in recent years, a technique has been developed of recognizing the lesion 36 by executing object recognition processing on the medical image 29 via a trained model that has been optimized by training a model (for example, a neural network) through machine learning, and displaying a recognition result of the object recognition processing or information based on the recognition result of the object recognition processing on the screen 35.

For example, the trained model is mounted in the server 2. The endoscope device 10 requests the server 2 to execute the object recognition processing, and the server 2 transmits an execution result of the object recognition processing to the endoscope device 10. Then, the endoscope device 10 displays the execution result on the screen 35.

Here, a case will be considered in which a processing content of the object recognition processing is switched in the server 2. A switching content in a case in which the processing content of the object recognition processing is switched in the server 2 is information that can be referred to by the doctor 12 in performing an accurate medical treatment. However, it is difficult for the doctor 12 who is performing the endoscopy using the endoscope device 10 to understand, only from the execution result displayed on the screen 35, the switching content in a case in which the processing content of the object recognition processing is switched in the server 2. In addition, this difficulty is not limited to the endoscopy, and is also applicable to other types of medical examinations (for example, a radiography examination, an MRI examination, or a CT examination).

Therefore, in view of such circumstances, in the present embodiment, as shown in FIG. 4 as an example, the medical support process is executed by the processor 100 of the server 2. A medical support program 108, a first recognition model 110A, and a second recognition model 110B are stored in the storage 104. The medical support program 108 is an example of a “program” according to the present disclosure. The processor 100 reads out the medical support program 108 from the storage 104 and executes the readout medical support program 108 on the memory 102 to execute the medical support process. The medical support process is realized by the processor 100 operating as a controller 100A and a recognition unit 100B in accordance with the medical support program 108 executed on the memory 102. As will be described in more detail later, the first recognition model 110A and the second recognition model 110B are used by the recognition unit 100B.

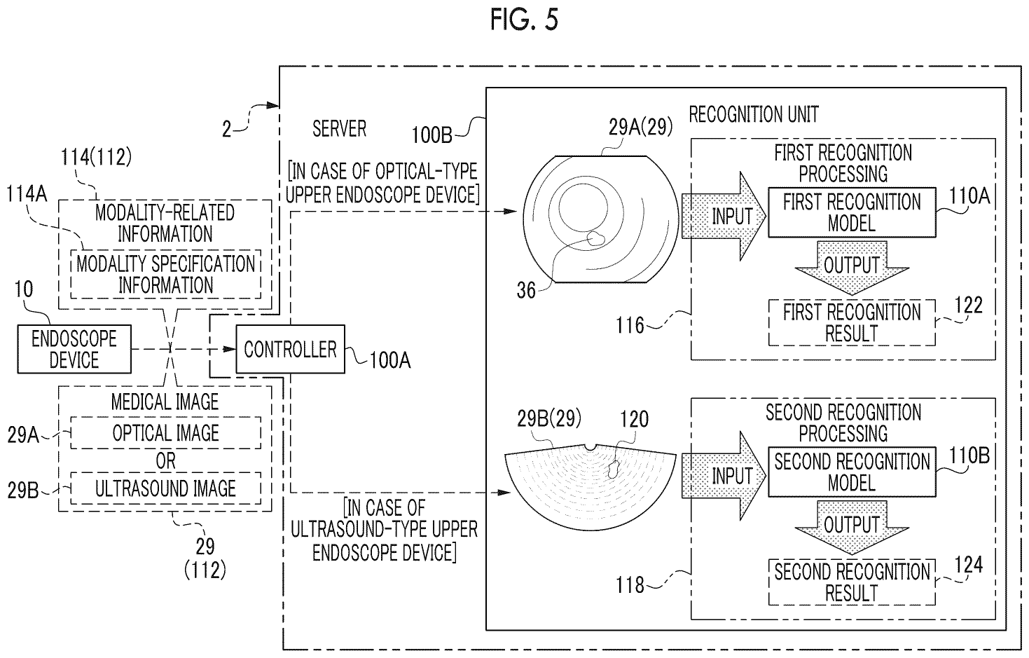

FIG. 5 is a conceptual diagram showing an example of the processing contents executed by the server 2 and the endoscope device 10. As shown in FIG. 5, the server 2 communicates with the endoscope device 10. The endoscope device 10 transmits medical information 112 to the server 2. In the server 2, the controller 100A receives the medical information 112 via the external I/F 98 (see FIG. 4). The medical image 29 and modality-related information 114 are included in the medical information 112.

The medical image 29 is an image obtained by imaging the inside of the body of the subject 26 via the endoscope device 10. In the example shown in FIG. 5, as an example of the medical image 29 transmitted from the endoscope device 10 to the server 2, the optical image 29A or the ultrasound image 29B is shown.

The modality-related information 114 is information on the endoscope device 10 at a timing at which the medical image 29 is obtained. A first example of the timing at which the medical image 29 is obtained is a period from a point in time at which the imaging is started for a predetermined number of frames to a point in time at which the imaging ends. In addition, a second example of the timing at which the medical image 29 is obtained is a timing at which the imaging for a predetermined number of frames is started. In addition, a third example of the timing at which the medical image 29 is obtained is a timing at which the imaging for a predetermined number of frames ends (for example, a timing at which the optical image 29A is generated or a timing at which the ultrasound image 29B is generated).

Modality specification information 114A is included in the modality-related information 114. The modality specification information 114A is information for specifying a type of the upper endoscope device currently being used in the endoscope device 10. That is, the modality specification information 114A can also be said to be information (for example, an identifier) for specifying whether the optical-type upper endoscope device is currently being used or the ultrasound-type upper endoscope device is currently being used. A computer (not shown) is mounted in the endoscope body 16, and the modality specification information 114A is held by the computer of the endoscope body 16. A content of the modality specification information 114A is changed in association with the change in the type of the upper endoscope device used in the endoscope device 10. The processor 72 of the control device 22 acquires the modality specification information 114A from the endoscope body 16 at a timing at which the content of the modality specification information 114A is changed. The processor 72 transmits the modality specification information 114A acquired from the endoscope body 16 to the server 2 via the function expansion device 24.

In the server 2, the controller 100A outputs the medical image 29 to the recognition unit 100B. The recognition unit 100B recognizes the feature region (for example, a lesion, an organ, and the like) in the medical image 29 based on the medical image 29 input from the controller 100A. In order to realize this, the recognition unit 100B executes first recognition processing 116 and second recognition processing 118. The first recognition processing 116 and the second recognition processing 118 are examples of “first processing” and “AI processing” according to the present disclosure.

In the first recognition processing 116, geometrical characteristics (for example, a position, a size, and a shape) of the lesion 36 shown in the optical image 29A, a type of the lesion 36, and a subtype (for example, a tumor type, a localized ulcer type, an infiltrative ulcer type, and a diffuse infiltrative type) of the lesion 36 are recognized based on the optical image 29A. Further, in the first recognition processing 116, a part (hereinafter, simply referred to as “first part”) shown in the optical image 29A is recognized based on the optical image 29A. Here, the first part refers to a part of the upper gastrointestinal tract 28. Examples of the first part include an esophagus, a cardiac region, a fundus, an upper part of a gastric body, a middle part of the gastric body, a lower part of the gastric body, a gastric angle, an antrum, a pylorus, a duodenal bulb, and a duodenum.

Each time the optical image 29A is acquired by the recognition unit 100B, the first recognition processing 116 is executed on the acquired optical image 29A. The first recognition processing 116 is processing of recognizing the lesion 36 and the first part via a method using AI. Here, processing using the first recognition model 110A is executed as the first recognition processing 116.

The first recognition model 110A is a trained model for object recognition via a bounding box method using AI. The first recognition model 110A has been optimized by training a neural network through machine learning using first training data that is a data set including a plurality of data (that is, data for a plurality of frames) in which first example data and first correct answer data are associated with each other. That is, the first recognition model 110A is a trained model that has been optimized to receive input of the first example data to generate the first correct answer data.

The first example data is an image corresponding to the optical image 29A (in other words, a sample image assuming the optical image 29A). The image corresponding to the optical image 29A is an example of “first information” and a “first image” according to the present disclosure. An example of the image corresponding to the optical image 29A is an image obtained by actually imaging the inside of the upper gastrointestinal tract via the camera. A second example of the image corresponding to the optical image 29A is a virtually generated image (for example, an image generated by generative AI).

The first correct answer data is information corresponding to information on the optical image 29A (for example, information for specifying the lesion 36 and the first part that are shown in the optical image 29A). The information corresponding to the information on the optical image 29A is an example of “second information” and a “second image” according to the present disclosure.

In the present embodiment, the first correct answer data refers to correct answer data (that is, an annotation) for the first example data. Here, as an example of the first correct answer data, an annotation is used for specifying the geometrical characteristics of the lesion shown in the image used as the first example data, the type of the lesion, the subtype of the lesion, and the first part.

The recognition unit 100B acquires the optical image 29A from the controller 100A and inputs the acquired optical image 29A to the first recognition model 110A. As a result, each time the optical image 29A is input, the first recognition model 110A recognizes the lesion 36 and the first part that are shown in the input optical image 29A, generates a first recognition result 122 that is a recognition result, and outputs the generated first recognition result 122. In the present embodiment, the first recognition result 122 is an example of an “execution result”, “related information”, and “feature region specification information” according to the present disclosure.

On the other hand, in the second recognition processing 118, geometrical characteristics (for example, a position, a size, and a shape) of a lesion 120 shown in the ultrasound image 29B, a type of the lesion 120, and a subtype of the lesion 120 are recognized based on the ultrasound image 29B. Further, in the second recognition processing 118, a part (hereinafter, simply referred to as “second part”) shown in the ultrasound image 29B is recognized based on the ultrasound image 29B. Here, the second part refers to a part recognized by the ultrasound-type upper endoscope device. Examples of the second part include organs such as a pancreas, a bile duct, a gallbladder, and a liver.

Each time the ultrasound image 29B is acquired by the recognition unit 100B, the second recognition processing 118 is executed on the acquired ultrasound image 29B. The second recognition processing 118 is processing of recognizing the lesion 120 and the second part via a method using AI. Here, processing using the second recognition model 110B is executed as the second recognition processing 118.

The second recognition model 110B is a trained model for object recognition via a bounding box method using AI. The second recognition model 110B has been optimized by training a neural network through machine learning using second training data that is a data set including a plurality of data (that is, data for a plurality of frames) in which second example data and second correct answer data are associated with each other. That is, the second recognition model 110B is a trained model that has been optimized to receive input of the second example data to generate the second correct answer data.

The second example data is an image corresponding to the ultrasound image 29B (in other words, a sample image assuming the ultrasound image 29B). The image corresponding to the ultrasound image 29B is an example of “first information” and a “first image” according to the present disclosure. An example of the image corresponding to the ultrasound image 29B is an image generated based on the reflected wave obtained by actually emitting the ultrasound wave inside the upper gastrointestinal tract via the ultrasound-type upper endoscope device. A second example of the image corresponding to the ultrasound image 29B is a virtually generated image (for example, an image generated by generative AI).

The second correct answer data is information corresponding to information on the ultrasound image 29B (for example, information for specifying the lesion 120 and the second part that are shown in the ultrasound image 29B). The information corresponding to the information on the ultrasound image 29B is an example of “second information” and a “second image” according to the present disclosure.

In the present embodiment, the second correct answer data refers to correct answer data (that is, an annotation) for the second example data. Here, as an example of the second correct answer data, an annotation is used for specifying the geometrical characteristics of the lesion shown in the image used as the second example data, the type of the lesion, the subtype of the lesion, and the second part.

The recognition unit 100B acquires the ultrasound image 29B from the controller 100A and inputs the acquired ultrasound image 29B to the second recognition model 110B. As a result, each time the ultrasound image 29B is input, the second recognition model 110B recognizes the lesion 120 and the second part that are shown in the input ultrasound image 29B, generates a second recognition result 124 that is a recognition result, and outputs the generated second recognition result 124. In the present embodiment, the second recognition result 124 is an example of an “execution result”, “related information”, and “feature region specification information” according to the present disclosure.

The controller 100A switches a processing content in the recognition unit 100B in accordance with the modality-related information 114. In the example shown in FIG. 5, the controller 100A switches the processing content in the recognition unit 100B in accordance with the modality specification information 114A. That is, the controller 100A selectively executes the first recognition processing 116 and the second recognition processing 118 in accordance with the modality specification information 114A.

In a case in which it is specified that the type of the upper endoscope device currently being used in the endoscope device 10 is the optical-type upper endoscope device by referring to the modality specification information 114A, the controller 100A outputs the optical image 29A to the recognition unit 100B and causes the recognition unit 100B to execute the first recognition processing 116. That is, the recognition unit 100B inputs the optical image 29A to the first recognition model 110A.

In a case in which it is specified that the type of the upper endoscope device currently being used in the endoscope device 10 is the ultrasound-type upper endoscope device by referring to the modality specification information 114A, the controller 100A outputs the ultrasound image 29B to the recognition unit 100B and causes the recognition unit 100B to execute the second recognition processing 118. That is, the recognition unit 100B inputs the ultrasound image 29B to the second recognition model 110B.

As described above, the first recognition model 110A and the second recognition model 110B are present in the server 2, and the trained model as an input destination for the medical image 29 is switched in accordance with the modality specification information 114A in the processing of the recognition unit 100B. That is, the controller 100A causes the recognition unit 100B to selectively use the first recognition model 110A and the second recognition model 110B in accordance with the modality specification information 114A.

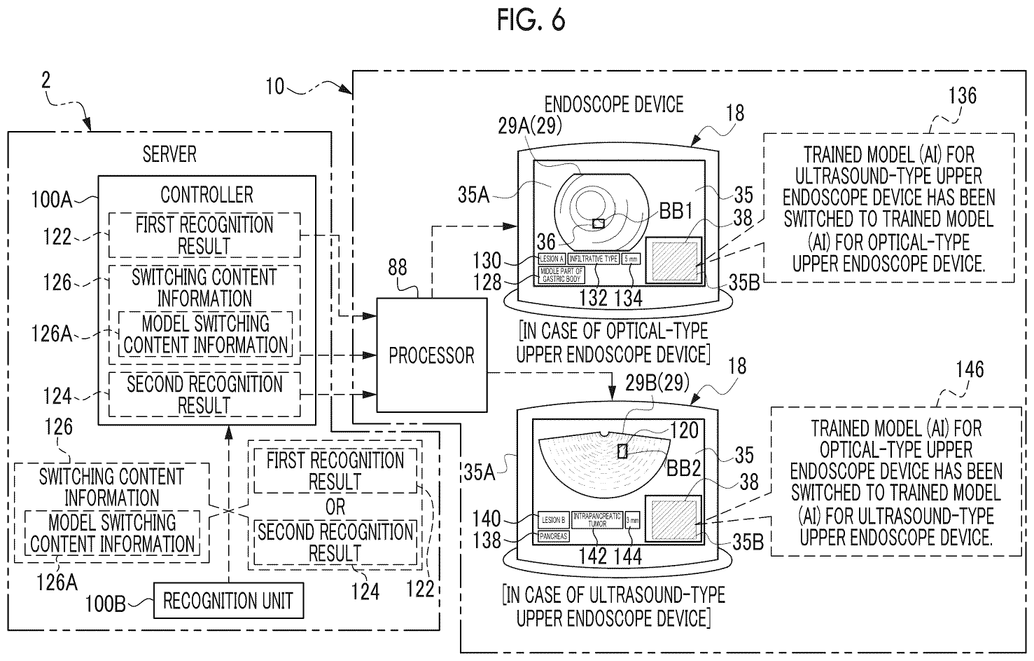

FIG. 6 is a conceptual diagram showing an example of the processing contents in the server 2 and the endoscope device 10. As shown in FIG. 6, in a case in which the first recognition processing 116 is executed by the recognition unit 100B, the recognition unit 100B outputs the first recognition result 122 to the controller 100A. In addition, in a case in which the second recognition processing 118 is executed by the recognition unit 100B, the recognition unit 100B outputs the second recognition result 124 to the controller 100A. Further, in a case in which the first recognition processing 116 is switched to the second recognition processing 118 by the recognition unit 100B, or in a case in which the second recognition processing 118 is switched to the first recognition processing 116 by the recognition unit 100B, the recognition unit 100B generates switching content information 126 and outputs the generated switching content information 126 to the controller 100A.

The switching content information 126 is information indicating the switching content in a case in which the processing content in the recognition unit 100B is switched (that is, the content in which the processing content in the recognition unit 100B is switched). Examples of the switching content information 126 in a case in which the processing executed by the recognition unit 100B is switched from the second recognition processing 118 to the first recognition processing 116 include information for specifying an event in which the second recognition processing 118 is switched to the first recognition processing 116 by the recognition unit 100B. In addition, examples of the switching content information 126 in a case in which the processing executed by the recognition unit 100B is switched from the first recognition processing 116 to the second recognition processing 118 include information for specifying an event in which the processing executed by the recognition unit 100B is switched from the first recognition processing 116 to the second recognition processing 118.

Model switching content information 126A is included in the switching content information 126. The model switching content information 126A is information indicating the content in which the trained model is switched, in a case in which the trained model as the input destination for the medical image 29 is switched. Examples of the model switching content information 126A in a case in which the trained model used by the recognition unit 100B is switched from the second recognition model 110B to the first recognition model 110A include information for specifying an event in which the trained model to which the medical image 29 is input is switched from the second recognition model 110B (that is, a trained model for the ultrasound-type upper endoscope device) to the first recognition model 110A (that is, a trained model for the optical-type upper endoscope device). In addition, examples of the model switching content information 126A in a case in which the trained model used by the recognition unit 100B is switched from the first recognition model 110A to the second recognition model 110B include information for specifying an event in which the trained model to which the medical image 29 is input is switched from the first recognition model 110A (that is, the trained model for the optical-type upper endoscope device) to the second recognition model 110B (that is, the trained model for the ultrasound-type upper endoscope device).

In the present embodiment, the switching content information 126 is an example of “switching content information” according to the present disclosure, and the model switching content information 126A is an example of “AI processing switching content information” and “model switching content information” according to the present disclosure.

The controller 100A transmits the first recognition result 122, the second recognition result 124, and the switching content information 126, which are input from the recognition unit 100B, to the endoscope device 10 via the external I/F 98 (see FIG. 4). In the endoscope device 10, the processor 88 receives the first recognition result 122, the second recognition result 124, and the switching content information 126 via the external I/F 86.

In a case in which the first recognition result 122 is received by the processor 88 via the external I/F 86, the processor 88 generates first part name information 128, first lesion identification information 130, first discrimination information 132, and first size information 134 as information based on the first recognition result 122, and displays the first part name information 128, the first lesion identification information 130, the first discrimination information 132, and the first size information 134 in the first display region 35A. The first part name information 128, the first lesion identification information 130, the first discrimination information 132, and the first size information 134 are displayed at positions different from a position at which the optical image 29A is displayed.

The first part name information 128 is information indicating a name of the first part recognized by executing the first recognition processing 116. The first lesion identification information 130 is information for identifying the lesion 36 recognized by the first recognition processing 116. The first discrimination information 132 is information indicating a result of discrimination of the lesion 36 (for example, a degree of malignancy). The first size information 134 is information indicating the size of the lesion 36 recognized by executing the first recognition processing 116. Here, the first discrimination information 132 and the first size information 134 are described as examples, but information other than the first discrimination information 132 and the first size information 134 (for example, a feature value map or the like) may be displayed on the screen 35 as long as the information indicates the characteristics of the lesion 36.

In a case in which the optical image 29A is displayed in the first display region 35A (that is, in a case in which the optical image 29A used for the first recognition processing 116 is displayed in the first display region 35A), the processor 88 displays a bounding box BB1 generated in accordance with the geometrical characteristics of the lesion 36 recognized by executing the first recognition processing 116, in a superimposed state on the optical image 29A displayed in the first display region 35A (for example, the optical image 29A used for the first recognition processing 116). In the example shown in FIG. 6, the bounding box BB1 is displayed in a superimposed state at a position at which the lesion 36 is shown in the optical image 29A displayed in the first display region 35A. The display of the bounding box BB1 is updated in synchronization with a display timing of the optical image 29A newly displayed in the first display region 35A (that is, a timing at which the optical image 29A displayed in the first display region 35A is updated).

It should be noted that, although the bounding box BB1 is described here, this is merely an example, and the processor 88 may display an identifier (for example, a mark defined at four corners of a rectangular frame) instead of the bounding box BB1 on the screen 35 (in the example shown in FIG. 6, the first display region 35A in the screen 35).

In a case in which the trained model used by the recognition unit 100B is switched from the second recognition model 110B to the first recognition model 110A, the processor 88 converts the model switching content information 126A included in the switching content information 126 into text and displays the converted text in the second display region 35B. A message 136 is displayed in the second display region 35B as one of the pieces of auxiliary information 38. The message 136 is a message indicating an event in which the trained model for the ultrasound-type upper endoscope device is switched to the trained model for the optical-type upper endoscope device.

In a case in which the second recognition result 124 is received by the processor 88 via the external I/F 86, the processor 88 generates second part name information 138, second lesion identification information 140, second discrimination information 142, and second size information 144 as information based on the second recognition result 124, and displays the second part name information 138, the second lesion identification information 140, the second discrimination information 142, and the second size information 144 in the first display region 35A. The second part name information 138, the second lesion identification information 140, the second discrimination information 142, and the second size information 144 are displayed at positions different from a position at which the ultrasound image 29B is displayed.

The second part name information 138 is information indicating a name of the second part recognized by executing the second recognition processing 118. The second lesion identification information 140 is information for identifying the lesion 120 recognized by the second recognition processing 118. The second discrimination information 142 is information indicating a result of discrimination of the lesion 120 (for example, a degree of malignancy). The second size information 144 is information indicating the size of the lesion 120 recognized by executing the second recognition processing 118. Here, the second discrimination information 142 and the second size information 144 are described as examples, but information other than the second discrimination information 142 and the second size information 144 (for example, a feature value map or the like) may be displayed on the screen 35 as long as the information indicates the characteristics of the lesion 120.

In a case in which the ultrasound image 29B is displayed in the first display region 35A (that is, in a case in which the ultrasound image 29B used for the second recognition processing 118 is displayed in the first display region 35A), the processor 88 displays a bounding box BB2 generated in accordance with the geometrical characteristics of the lesion 120 recognized by executing the second recognition processing 118, in a superimposed state on the ultrasound image 29B displayed in the first display region 35A (for example, the ultrasound image 29B used for the second recognition processing 118). In the example shown in FIG. 6, the bounding box BB2 is displayed in a superimposed state at a position at which the lesion 120 is shown in the ultrasound image 29B displayed in the first display region 35A. The display of the bounding box BB2 is updated in synchronization with a display timing of the ultrasound image 29B newly displayed in the first display region 35A (that is, a timing at which the ultrasound image 29B displayed in the first display region 35A is updated).

It should be noted that, although the bounding box BB2 is described here, this is merely an example, and the processor 88 may display an identifier (for example, a mark defined at four corners of a rectangular frame) instead of the bounding box BB2 on the screen 35 (in the example shown in FIG. 6, the first display region 35A in the screen 35).

In a case in which the trained model used by the recognition unit 100B is switched from the first recognition model 110A to the second recognition model 110B, the processor 88 converts the model switching content information 126A included in the switching content information 126 into text and displays the converted text in the second display region 35B. A message 146 is displayed in the second display region 35B as one of the pieces of auxiliary information 38. The message 146 is a message indicating an event in which the trained model for the optical-type upper endoscope device is switched to the trained model for the ultrasound-type upper endoscope device.

It should be noted that, in the example shown in FIG. 6, the form example is described in which the messages 136 and 146 are displayed in the second display region 35B, but this is merely an example. Information in any form may be used as long as the information allows the doctor 12 to perceive the event in which the trained model for the ultrasound-type upper endoscope device is switched to the trained model for the optical-type upper endoscope device or the event in which the trained model for the optical-type upper endoscope device is switched to the trained model for the ultrasound-type upper endoscope device. A first example of the information for allowing the perception of the doctor 12 is visible information (for example, a mark and/or a code) indicating the event in which the trained model for the ultrasound-type upper endoscope device is switched to the trained model for the optical-type upper endoscope device or the event in which the trained model for the optical-type upper endoscope device is switched to the trained model for the ultrasound-type upper endoscope device. A second example of the information for allowing the perception of the doctor 12 is audible information (for example, voice) indicating the event in which the trained model for the ultrasound-type upper endoscope device is switched to the trained model for the optical-type upper endoscope device or the event in which the trained model for the optical-type upper endoscope device is switched to the trained model for the ultrasound-type upper endoscope device.

In addition, in the example shown in FIG. 6, the form example is described in which the message 136 or 146 is displayed on the screen 35, but the message 136 or 146 or information substituted for the message 136 or 146 may be stored in the storage medium. In addition, the message 136 or 146 or the information substituted for the message 136 or 146 may be stored in the storage medium in a state of being associated with at least a part (for example, the medical image 29 and the modality-related information 114 that correspond to each other) of the medical information 112 (see FIG. 5).

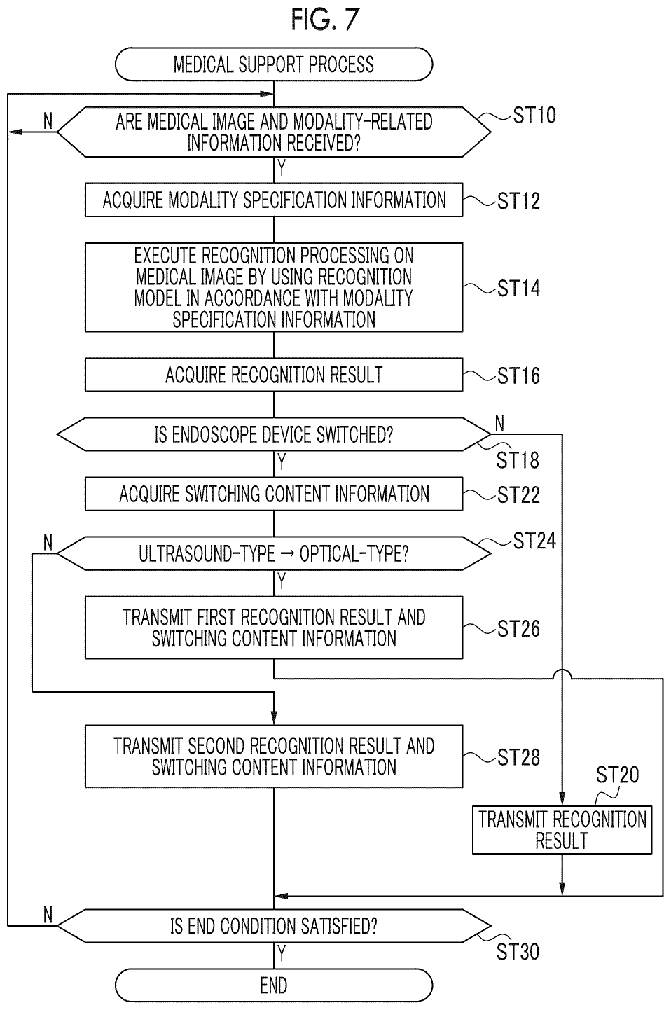

Next, an operation of a part of the medical support system 1 according to the embodiment of the present disclosure will be described with reference to FIG. 7. A flow of the medical support process shown in FIG. 7 is an example of an “operation method of a medical support device” according to the present disclosure.

In the medical support process shown in FIG. 7, first, in step ST10, the controller 100A determines whether or not the medical image 29 and the modality-related information 114 are received by the external I/F 98. In step ST10, in a case in which the medical image 29 and the modality-related information 114 are not received by the external I/F 98, a negative determination is made, and the determination in step ST10 is executed again. In step ST10, in a case in which the medical image 29 and the modality-related information 114 are received by the external I/F 98, an affirmative determination is made, and the medical support process proceeds to step ST12.

In step ST12, the controller 100A acquires the modality specification information 114A from the modality-related information 114 received by the external I/F 98 in step ST10. After the processing in step ST12 is executed, the medical support process proceeds to step ST14.

In step ST14, the controller 100A causes the recognition unit 100B to execute the first recognition processing 116 or the second recognition processing 118, in which the medical image 29 received by the external I/F 98 in step ST10 is a processing target, by using the first recognition model 110A or the second recognition model 110B in accordance with the modality specification information 114A acquired in step ST12. That is, in a case in which it is specified that the optical-type upper endoscope device is currently being used by referring to the modality specification information 114A, the controller 100A causes the recognition unit 100B to input the optical image 29A to the first recognition model 110A, thereby outputting the first recognition result 122 from the first recognition model 110A. In addition, in a case in which it is specified that the ultrasound-type upper endoscope device is currently being used by referring to the modality specification information 114A, the controller 100A causes the recognition unit 100B to input the ultrasound image 29B to the second recognition model 110B, thereby outputting the second recognition result 124 from the second recognition model 110B. After the processing in step ST14 is executed, the medical support process proceeds to step ST16.

In step ST16, in a case in which the first recognition processing 116 is executed by the recognition unit 100B, the controller 100A acquires the first recognition result 122 from the recognition unit 100B. In addition, in a case in which the second recognition processing 118 is executed by the recognition unit 100B, the controller 100A acquires the second recognition result 124 from the recognition unit 100B. After the processing in step ST16 is executed, the medical support process proceeds to step ST18.

In step ST18, the controller 100A determines whether or not one of the optical-type upper endoscope device or the ultrasound-type upper endoscope device is switched to the other thereof by referring to the modality specification information 114A acquired in step ST12. In step ST18, in a case in which one of the optical-type upper endoscope device or the ultrasound-type upper endoscope device is not switched to the other thereof, a negative determination is made, and the medical support process proceeds to step ST20.

In step ST20, the controller 100A transmits the first recognition result 122 or the second recognition result 124 acquired in step ST16 to the endoscope device 10 via the external I/F 98. In the endoscope device 10, the processor 88 displays the medical image 29 used for the first recognition processing 116 in the first display region 35A, and displays the information based on the first recognition result 122 or the second recognition result 124 transmitted from the controller 100A via the external I/F 98 by executing the processing in step ST20 in the first display region 35A. After the processing in step ST20 is executed, the medical support process proceeds to step ST30.

In step ST18, in a case in which one of the optical-type upper endoscope device or the ultrasound-type upper endoscope device is switched to the other thereof, an affirmative determination is made, and the medical support process proceeds to step ST22.

In a case in which one of the optical-type upper endoscope device or the ultrasound-type upper endoscope device is switched to the other thereof, the switching content information 126 is generated by the recognition unit 100B.

In step ST22, the controller 100A acquires the switching content information 126 generated by the recognition unit 100B from the recognition unit 100B. After the processing in step ST22 is executed, the medical support process proceeds to step ST24.

In step ST24, the controller 100A determines whether or not the switching from one of the optical-type upper endoscope device or the ultrasound-type upper endoscope device to the other thereof is the switching from the ultrasound-type upper endoscope device to the optical-type upper endoscope device. In step ST24, in a case in which the switching from one of the optical-type upper endoscope device or the ultrasound-type upper endoscope device to the other thereof is the switching from the ultrasound-type upper endoscope device to the optical-type upper endoscope device, an affirmative determination is made, and the medical support process proceeds to step ST26. In step ST24, in a case in which the switching from one of the optical-type upper endoscope device or the ultrasound-type upper endoscope device to the other thereof is not the switching from the ultrasound-type upper endoscope device to the optical-type upper endoscope device, a negative determination is made, and the medical support process proceeds to step ST28.

In step ST26, the controller 100A transmits the first recognition result 122 and the switching content information 126 to the endoscope device 10. The switching content information 126 transmitted to the endoscope device 10 by executing the processing in step ST26 is information for specifying the event in which the second recognition processing 118 is switched to the first recognition processing 116 by the recognition unit 100B. In addition, the switching content information 126 transmitted to the endoscope device 10 by executing the processing in step ST26 includes the model switching content information 126A. The model switching content information 126A included in the switching content information 126 in step ST26 is information for specifying the event in which the trained model to which the medical image 29 is input is switched from the second recognition model 110B (that is, the trained model for the ultrasound-type upper endoscope device) to the first recognition model 110A (that is, the trained model for the optical-type upper endoscope device). In the endoscope device 10, the processor 88 displays the optical image 29A used for the first recognition processing 116 in the first display region 35A, and displays the information based on the first recognition result 122 transmitted from the controller 100A via the external I/F 98 by executing the processing in step ST26 in the first display region 35A. In addition, the processor 88 displays the message 136 obtained by converting the switching content information 126, which is transmitted from the controller 100A via the external I/F 98 by executing the processing in step ST26, into text in the second display region 35B. After the processing in step ST26 is executed, the medical support process proceeds to step ST30.

In step ST28, the controller 100A transmits the second recognition result 124 and the switching content information 126 to the endoscope device 10. The switching content information 126 transmitted to the endoscope device 10 by executing the processing in step ST28 is information for specifying the event in which the first recognition processing 116 is switched to the second recognition processing 118 by the recognition unit 100B. In addition, the switching content information 126 transmitted to the endoscope device 10 by executing the processing in step ST28 includes the model switching content information 126A. The model switching content information 126A included in the switching content information 126 in step ST28 is information for specifying the event in which the trained model to which the medical image 29 is input is switched from the first recognition model 110A (that is, the trained model for the optical-type upper endoscope device) to the second recognition model 110B (that is, the trained model for the ultrasound-type upper endoscope device). In the endoscope device 10, the processor 88 displays the ultrasound image 29B used for the second recognition processing 118 in the first display region 35A, and displays the information based on the second recognition result 124 transmitted from the controller 100A via the external I/F 98 by executing the processing in step ST28 in the first display region 35A. In addition, the processor 88 displays the message 146 obtained by converting the switching content information 126, which is transmitted from the controller 100A via the external I/F 98 by executing the processing in step ST28, into text in the second display region 35B. After the processing in step ST28 is executed, the medical support process proceeds to step ST30. In Step ST30, the processor 88 determines whether or not a medical support process end condition is satisfied. An example of the medical support process end condition is a condition that an instruction for the endoscope device 10 to end the medical support process is given (for example, a condition that the receiving device 64 receives an instruction to end the medical support process). In a case in which the medical support process end condition is not satisfied in Step ST30, the determination result is “No”, and the medical support process proceeds to Step ST10. In a case in which the medical support process end condition is satisfied in Step ST30, the determination result is “Yes”, and the medical support process ends.

As described above, in the medical support system 1, the medical information 112 transmitted from the endoscope device 10 is received by the server 2. In the server 2, the first recognition processing 116 and the second recognition processing 118 included in the medical information 112 are selectively executed. The first recognition processing 116 is executed on the optical image 29A, and the second recognition processing 118 is executed on the ultrasound image 29B. The first recognition result 122 obtained by executing the first recognition processing 116 on the optical image 29A and the second recognition result 124 obtained by executing the second recognition processing 118 on the ultrasound image 29B are selectively transmitted from the server 2 to the endoscope device 10. The first recognition processing 116 and the second recognition processing 118 executed by the server 2 are switched in accordance with the modality-related information 114. Then, in a case in which one of the first recognition processing 116 or the second recognition processing 118 is switched to the other thereof, the switching content information 126 is transmitted from the server 2 to the endoscope device 10.

In the endoscope device 10, the information based on the first recognition result 122 transmitted from the server 2 or the information based on the second recognition result 124 transmitted from the server 2 is displayed on the screen 35. In addition, in the endoscope device 10, the message 136 or 146 obtained by converting the switching content information 126, which is transmitted from the server 2, into text is displayed on the screen 35. The switching content information 126 is information indicating the switching content in a case in which the processing content in the recognition unit 100B is switched.

Therefore, the doctor 12 can understand the information based on the first recognition result 122 or the information based on the second recognition result 124 through the screen 35. In addition, the doctor 12 can understand the switching content in a case in which the processing content in the recognition unit 100B is switched through the screen 35. That is, the doctor 12 can understand the content in which one of the first recognition processing 116 or the second recognition processing 118 is switched to the other thereof through the screen 35. In addition, the doctor 12 can understand the event in which the trained model for the ultrasound-type upper endoscope device is switched to the trained model for the optical-type upper endoscope device or the event in which the trained model for the optical-type upper endoscope device is switched to the trained model for the ultrasound-type upper endoscope device, through the message 136 or 146 obtained by converting the model switching content information 126A included in the switching content information 126 into text. Further, the doctor 12 can understand whether the trained model currently being used by the recognition unit 100B is the first recognition model 110A or the second recognition model 110B through the message 136 or 146 displayed on the screen 35.

In addition, in the medical support system 1, a plurality of types of trained models (that is, the first recognition model 110A and the second recognition model 110B) as the input destinations of the medical image 29 are switched in accordance with the modality-related information 114 (here, as an example, the modality specification information 114A). As a result, the medical image 29 can be input to a more appropriate trained model than in a case in which the plurality of types of trained models as the input destinations of the medical image 29 are switched regardless of the modality-related information 114 (here, as an example, the modality specification information 114A).

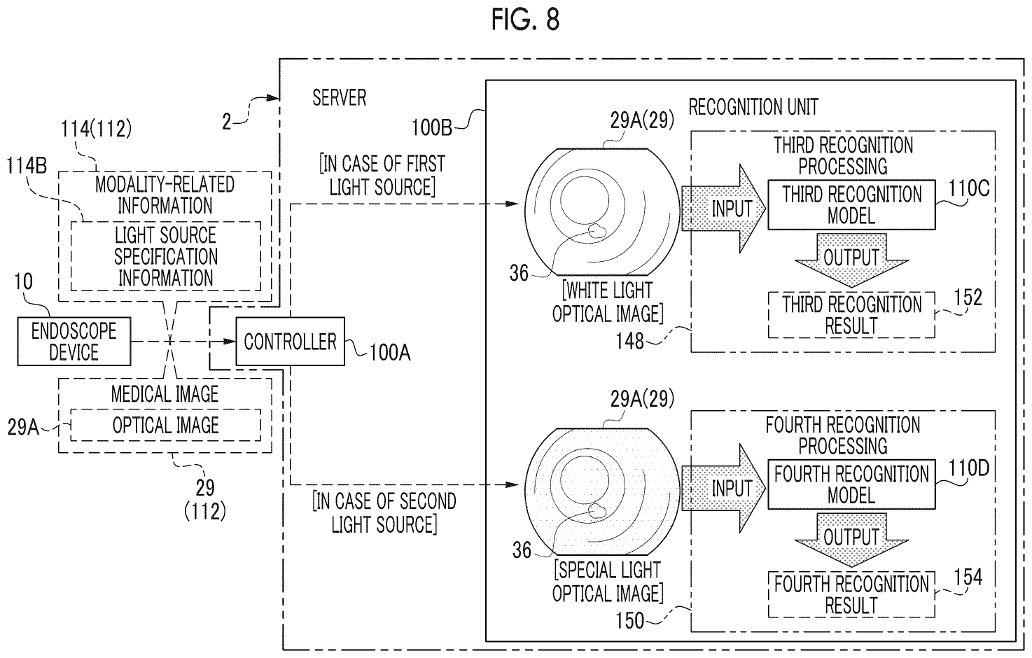

It should be noted that, in the above-described embodiment, the form example is described in which the modality specification information 114A is included in the modality-related information 114, but this is merely an example. For example, as shown in FIG. 8, the modality-related information 114 may include light source specification information 114B.

The light source specification information 114B is information for specifying a light source used for the imaging to obtain the optical image 29A. The light source used for the imaging to obtain the optical image 29A is classified into a first light source that emits white light and a second light source that emits special light. Here, for convenience of description, a light source that emits the light for LCI is described as an example of the second light source, but this is merely an example, and the present disclosure is applicable even in a case in which a light source that emits the light for BLI is used as the second light source.

The light source specification information 114B is held by the computer (not shown) of the endoscope body 16. A content of the light source specification information 114B is changed by the change from one of the first light source or the second light source to the other thereof. The processor 72 of the control device 22 acquires the light source specification information 114B from the endoscope body 16 at a timing at which the content of the light source specification information 114B is changed. The processor 72 transmits the light source specification information 114B acquired from the endoscope body 16 to the server 2 via the function expansion device 24.

In the server 2, the controller 100A outputs the optical image 29A to the recognition unit 100B. The recognition unit 100B recognizes the feature region (for example, a lesion or an organ) in the optical image 29A based on the optical image 29A input from the controller 100A. In order to realize this, the recognition unit 100B executes third recognition processing 148 and fourth recognition processing 150. The third recognition processing 148 and the fourth recognition processing 150 are examples of “first processing” and “AI processing” according to the present disclosure.

In the third recognition processing 148, based on an image (hereinafter referred to as “white light optical image”) obtained as the optical image 29A by imaging the inside of the upper gastrointestinal tract 28 via the camera 60 in a state in which the white light is emitted by the illumination device 58 inside the upper gastrointestinal tract 28, the geometrical characteristics of the lesion 36 shown in the white light optical image, the type of the lesion 36, the subtype of the lesion 36, and the like are recognized. Further, in the third recognition processing 148, the first part is recognized based on the white light optical image.

Each time the white light optical image is acquired by the recognition unit 100B, the third recognition processing 148 is executed on the acquired white light optical image. The third recognition processing 148 is processing of recognizing the lesion 36 and the first part via a method using AI. Here, processing using a third recognition model 110C is executed as the third recognition processing 148.

The third recognition model 110C is a trained model for object recognition via a bounding box method using AI. The third recognition model 110C has been optimized by training a neural network through machine learning using third training data that is a data set including a plurality of data (that is, data for a plurality of frames) in which third example data and third correct answer data are associated with each other. That is, the third recognition model 110C is a trained model that has been optimized to receive input of the third example data to generate the third correct answer data.

The third example data is an image corresponding to the white light optical image (in other words, an image assuming the white light optical image). The image corresponding to the white light optical image is an example of “first information” and a “first image” according to the present disclosure.

The third correct answer data is information corresponding to information on the white light optical image (for example, information for specifying the lesion 36 and the first part that are shown in the white light optical image). The information corresponding to the information on the white light optical image is an example of “second information” and a “second image” according to the present disclosure.

The third correct answer data refers to correct answer data (that is, an annotation) for the third example data. Here, as an example of the third correct answer data, an annotation is used for specifying the geometrical characteristics of the lesion shown in the image used as the third example data, the type of the lesion, the subtype of the lesion, and the first part.

The recognition unit 100B acquires the white light optical image from the controller 100A and inputs the white light optical image acquired from the controller 100A to the third recognition model 110C. As a result, each time the white light optical image is input, the third recognition model 110C recognizes the lesion 36 and the first part that are shown in the input white light optical image, generates a third recognition result 152 that is a recognition result, and outputs the generated third recognition result 152. The third recognition result 152 is an example of an “execution result”, “related information”, and “feature region specification information” according to the present disclosure.

Meanwhile, in the fourth recognition processing 150, based on an image (hereinafter referred to as “special light optical image”) obtained as the optical image 29A by imaging the inside of the upper gastrointestinal tract 28 via the camera 60 in a state in which the special light is emitted by the illumination device 58 inside the upper gastrointestinal tract 28, the geometrical characteristics of the lesion 36 shown in the special light optical image, the type of the lesion 36, the subtype of the lesion 36, and the like are recognized. Further, in the fourth recognition processing 150, the first part is recognized based on the special light optical image.

Each time the special light optical image is acquired by the recognition unit 100B, the fourth recognition processing 150 is executed on the acquired special light optical image. The fourth recognition processing 150 is processing of recognizing the lesion 36 and the first part via a method using AI. Here, processing using a fourth recognition model 110D is executed as the fourth recognition processing 150.

The fourth recognition model 110D is a trained model for object recognition via a bounding box method using AI. The fourth recognition model 110D has been optimized by training a neural network through machine learning using fourth training data that is a data set including a plurality of data (that is, data for a plurality of frames) in which fourth example data and fourth correct answer data are associated with each other. That is, the fourth recognition model 110D is a trained model that has been optimized to receive input of the fourth example data to generate the fourth correct answer data.

The fourth example data is an image corresponding to the special light optical image (in other words, an image assuming the special light optical image). The image corresponding to the special light optical image is an example of “first information” and a “first image” according to the present disclosure.

The fourth correct answer data is information corresponding to information on the special light optical image (for example, information for specifying the lesion 36 and the first part that are shown in the special light optical image). The information corresponding to the information on the special light optical image is an example of “second information” and a “second image” according to the present disclosure.

The fourth correct answer data refers to correct answer data (that is, an annotation) for the fourth example data. Here, as an example of the fourth correct answer data, an annotation is used for specifying the geometrical characteristics of the lesion shown in the image used as the fourth example data, the type of the lesion, the subtype of the lesion, and the first part.

The recognition unit 100B acquires the special light optical image from the controller 100A and inputs the special light optical image acquired from the controller 100A to the fourth recognition model 110D. As a result, each time the special light optical image is input, the fourth recognition model 110D recognizes the lesion 36 and the first part that are shown in the input special light optical image, generates a fourth recognition result 154 that is a recognition result, and outputs the generated fourth recognition result 154. The fourth recognition result 154 is an example of an “execution result”, “related information”, and “feature region specification information” according to the present disclosure.

The controller 100A switches the processing content in the recognition unit 100B in accordance with the light source specification information 114B. That is, the controller 100A selectively executes the third recognition processing 148 and the fourth recognition processing 150 in accordance with the light source specification information 114B.

In a case in which it is specified that the light source currently being used for the imaging in the upper gastrointestinal tract 28 is the first light source by referring to the light source specification information 114B, the controller 100A outputs the white light optical image to the recognition unit 100B and causes the recognition unit 100B to execute the third recognition processing 148. That is, the recognition unit 100B inputs the white light optical image to the third recognition model 110C.

In a case in which it is specified that the light source currently being used for the imaging in the upper gastrointestinal tract 28 is the second light source by referring to the light source specification information 114B, the controller 100A outputs the special light optical image to the recognition unit 100B and causes the recognition unit 100B to execute the fourth recognition processing 150. That is, the recognition unit 100B inputs the special light optical image to the fourth recognition model 110D.

As described above, in the server 2, the third recognition model 110C and the fourth recognition model 110D are present, and the trained model as the input destination for the optical image 29A is switched in accordance with the light source specification information 114B in the processing of the recognition unit 100B. That is, the controller 100A causes the recognition unit 100B to selectively use the third recognition model 110C and the fourth recognition model 110D in accordance with the light source specification information 114B.

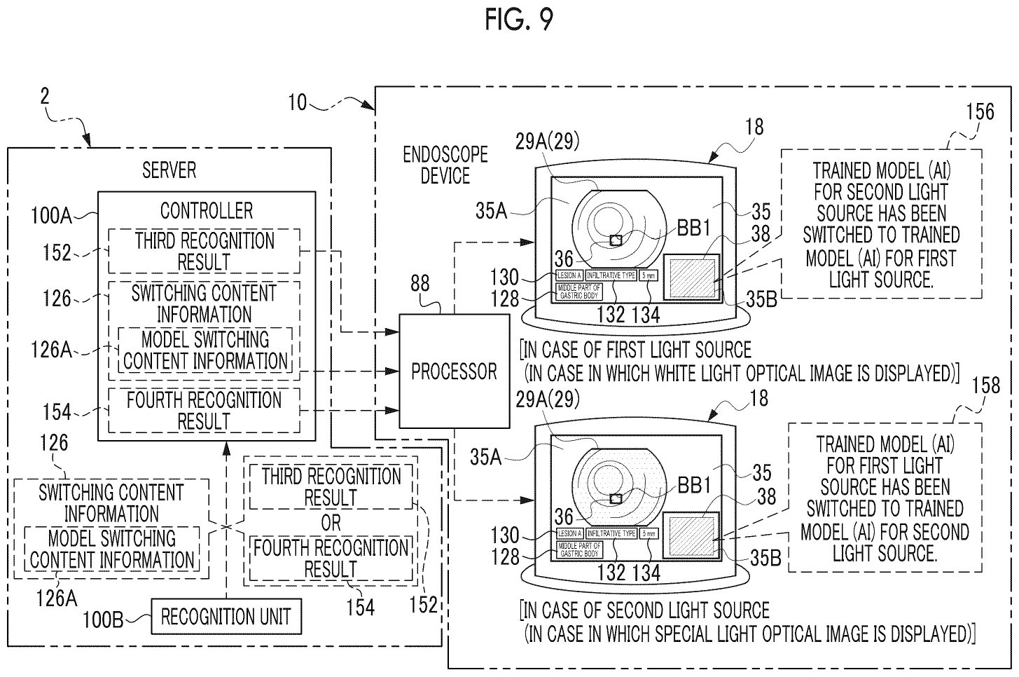

As an example, as shown in FIG. 9, in a case in which the third recognition processing 148 is executed by the recognition unit 100B, the recognition unit 100B outputs the third recognition result 152 to the controller 100A. In addition, in a case in which the fourth recognition processing 150 is executed by the recognition unit 100B, the recognition unit 100B outputs the fourth recognition result 154 to the controller 100A. Further, in a case in which the third recognition processing 148 is switched to the fourth recognition processing 150 by the recognition unit 100B, or in a case in which the fourth recognition processing 150 is switched to the third recognition processing 148 by the recognition unit 100B, the recognition unit 100B generates switching content information 126 and outputs the generated switching content information 126 to the controller 100A.

Examples of the switching content information 126 in a case in which the processing executed by the recognition unit 100B is switched from the fourth recognition processing 150 to the third recognition processing 148 include information for specifying an event in which the fourth recognition processing 150 is switched to the third recognition processing 148 by the recognition unit 100B. In addition, examples of the switching content information 126 in a case in which the processing executed by the recognition unit 100B is switched from the third recognition processing 148 to the fourth recognition processing 150 include information for specifying an event in which the processing executed by the recognition unit 100B is switched from the third recognition processing 148 to the fourth recognition processing 150.

Examples of the model switching content information 126A in a case in which the trained model used by the recognition unit 100B is switched from the fourth recognition model 110D to the third recognition model 110C include information for specifying an event in which the trained model to which the medical image 29 is input is switched from the fourth recognition model 110D (that is, a trained model for the second light source) to the third recognition model 110C (that is, a trained model for the first light source). Further, examples of the model switching content information 126A in a case in which the trained model used by the recognition unit 100B is switched from the third recognition model 110C to the fourth recognition model 110D include information for specifying an event in which the trained model to which the medical image 29 is input is switched from the third recognition model 110C (that is, a trained model for the first light source) to the fourth recognition model 110D (that is, a trained model for the second light source).

The controller 100A transmits the third recognition result 152, the fourth recognition result 154, and the switching content information 126, which are input from the recognition unit 100B, to the endoscope device 10 via the external I/F 98 (see FIG. 4). In the endoscope device 10, the processor 88 receives the third recognition result 152, the fourth recognition result 154, and the switching content information 126 via the external I/F 86.

In a case in which the third recognition result 152 is received by the processor 88 via the external I/F 86, the processor 88 generates the first part name information 128, the first lesion identification information 130, the first discrimination information 132, and the first size information 134 as information based on the third recognition result 152, and displays the first part name information 128, the first lesion identification information 130, the first discrimination information 132, and the first size information 134 in the first display region 35A.

In a case in which the white light optical image is displayed in the first display region 35A (that is, in a case in which the white light optical image used for the third recognition processing 148 is displayed in the first display region 35A), the processor 88 displays a bounding box BB1 generated in accordance with the geometrical characteristics of the lesion 36 recognized by executing the third recognition processing 148, in a superimposed state on the white light optical image displayed in the first display region 35A (for example, the white light optical image used for the third recognition processing 148). In the example shown in FIG. 9, the bounding box BB1 is displayed in a superimposed state at a position at which the lesion 36 is shown in the white light optical image displayed in the first display region 35A. The display of the bounding box BB1 is updated in synchronization with a display timing of the white light optical image newly displayed in the first display region 35A (that is, a timing at which the white light optical image displayed in the first display region 35A is updated).

In a case in which the trained model used by the recognition unit 100B is switched from the fourth recognition model 110D to the third recognition model 110C, the processor 88 converts the model switching content information 126A included in the switching content information 126 into text and displays the converted text in the second display region 35B. A message 156 is displayed in the second display region 35B as one of the pieces of auxiliary information 38. The message 156 is a message indicating an event in which the trained model for the second light source is switched to the trained model for the first light source.

In a case in which the fourth recognition result 154 is received by the processor 88 via the external I/F 86, the processor 88 generates the first part name information 128, the first lesion identification information 130, the first discrimination information 132, and the first size information 134 as information based on the fourth recognition result 154, and displays the first part name information 128, the first lesion identification information 130, the first discrimination information 132, and the first size information 134 in the first display region 35A.

In a case in which the special light optical image is displayed in the first display region 35A (that is, in a case in which the special light optical image used for the fourth recognition processing 150 is displayed in the first display region 35A), the processor 88 displays a bounding box BB1 generated in accordance with the geometrical characteristics of the lesion 36 recognized by executing the fourth recognition processing 150, in a superimposed state on the special light optical image displayed in the first display region 35A (for example, the special light optical image used for the fourth recognition processing 150). In the example shown in FIG. 9, the bounding box BB1 is displayed in a superimposed state at a position at which the lesion 36 is shown in the special light optical image displayed in the first display region 35A. The display of the bounding box BB1 is updated in synchronization with a display timing of the special light optical image newly displayed in the first display region 35A (that is, a timing at which the special light optical image displayed in the first display region 35A is updated).

In a case in which the trained model used by the recognition unit 100B is switched from the third recognition model 110C to the fourth recognition model 110D, the processor 88 converts the model switching content information 126A included in the switching content information 126 into text and displays the converted text in the second display region 35B. A message 158 is displayed in the second display region 35B as one of the pieces of auxiliary information 38. The message 158 is a message indicating an event in which the trained model for the first light source is switched to the trained model for the second light source.

It should be noted that, in the example shown in FIG. 9, the messages 156 and 158 are shown as examples, but the same modification examples as the modification examples of the messages 136 and 146 described in the above-described embodiment can be applied to the messages 156 and 158.

As described above, according to the examples shown in FIGS. 8 and 9, the modality-related information 114 includes the light source specification information 114B, and the trained model as the input destination for the optical image 29A is switched in accordance with the light source specification information 114B in the processing of the recognition unit 100B. The content in which the trained model is switched is displayed on the screen 35 as the message 156 or 158. Therefore, the doctor 12 can understand, from the message 156 or 158 displayed on the screen 35, the switching content in a case in which the processing content in the recognition unit 100B is switched in accordance with the type of the light source.

It should be noted that, in the examples shown in FIGS. 8 and 9, the form example is described in which one of the first light source (that is, the light source which emits the white light) or the second light source (that is, the light source which emits the special light) is switched to the other thereof, but this is merely an example, and the processing need only be executed in the same manner as in the examples shown in FIGS. 8 and 9 even in a case in which a plurality of types of special light (for example, the light for BLI and the light for LCI) are switched.

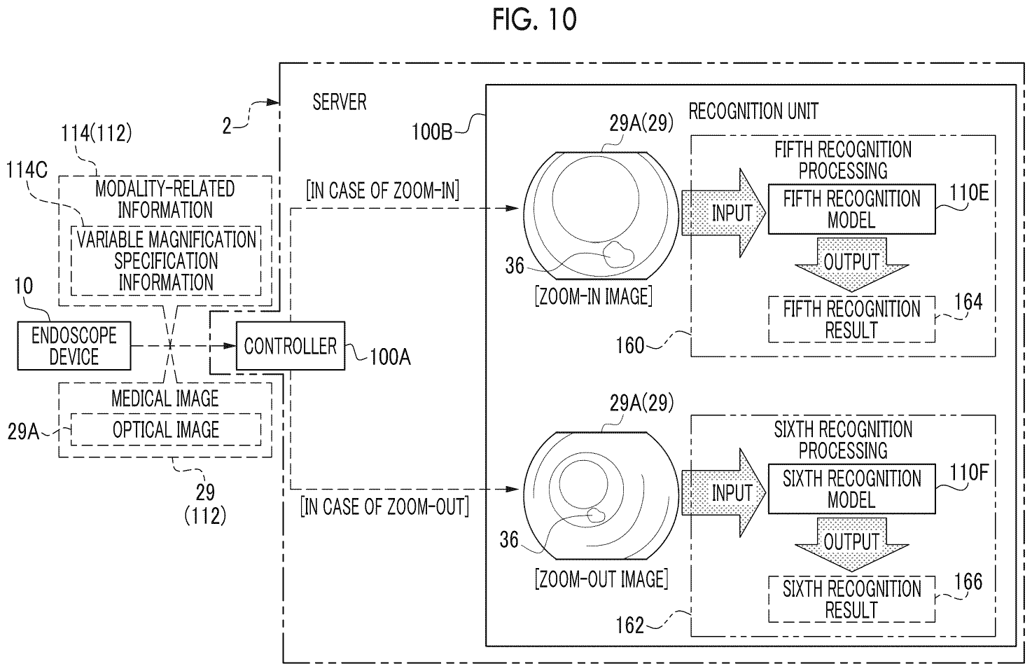

In the examples shown in FIGS. 8 and 9, the form example is described in which the modality-related information 114 includes the light source specification information 114B, and the third recognition model 110C and the fourth recognition model 110D are switched in accordance with the light source specification information 114B, but this is merely an example. For example, as shown in FIG. 10, the modality-related information 114 may include variable magnification specification information 114C, and the trained model used by the recognition unit 100B may be switched in accordance with the variable magnification specification information 114C.

The variable magnification specification information 114C is information for specifying the variable magnification applied to the medical image 29 (here, as an example, the optical image 29A). The information for specifying the variable magnification applied to the medical image 29 refers to, for example, information (for example, an identifier or a magnification) for specifying the variable magnification currently being applied to a zoom lens of the camera 60. Here, for convenience of description, as an example of the variable magnification, two-stage variable magnification of zoom-in and zoom-out will be described. Here, the zoom-in refers to zoom-in at a certain first magnification, and the zoom-out refers to zoom-out at a certain second magnification.

The variable magnification specification information 114C is held by the computer (not shown) of the endoscope body 16. A content of the variable magnification specification information 114C is changed as one of the zoom-in or the zoom-out is changed to the other thereof. The processor 72 of the control device 22 acquires the variable magnification specification information 114C from the endoscope body 16 at a timing at which the content of the variable magnification specification information 114C is changed. The processor 72 transmits the variable magnification specification information 114C acquired from the endoscope body 16 to the server 2 via the function expansion device 24.

In the server 2, the controller 100A outputs the optical image 29A to the recognition unit 100B. The recognition unit 100B recognizes the feature region (for example, a lesion or an organ) in the optical image 29A based on the optical image 29A input from the controller 100A. In order to realize this, the recognition unit 100B executes fifth recognition processing 160 and sixth recognition processing 162. The fifth recognition processing 160 and the sixth recognition processing 162 are examples of “first processing” and “AI processing” according to the present disclosure.

In the fifth recognition processing 160, based on an image (hereinafter referred to as “zoom-in image”) obtained as the optical image 29A by imaging the inside of the upper gastrointestinal tract 28 via the camera 60 in a zoom-in state, the geometrical characteristics of the lesion 36 shown in the zoom-in image, the type of the lesion 36, the subtype of the lesion 36, and the like are recognized. Further, in the fifth recognition processing 160, the first part is recognized based on the zoom-in image.

Each time the zoom-in image is acquired by the recognition unit 100B, the fifth recognition processing 160 is executed on the acquired zoom-in image. The fifth recognition processing 160 is processing of recognizing the lesion 36 and the first part via a method using AI. Here, processing using a fifth recognition model 110E is executed as the fifth recognition processing 160.

The fifth recognition model 110E is a trained model for object recognition via a bounding box method using AI. The fifth recognition model 110E has been optimized by training a neural network through machine learning using fifth training data that is a data set including a plurality of data (that is, data for a plurality of frames) in which fifth example data and fifth correct answer data are associated with each other. That is, the fifth recognition model 110E is a trained model that has been optimized to receive input of the fifth example data to generate the fifth correct answer data.

The fifth example data is an image corresponding to the zoom-in image (in other words, an image assuming the zoom-in image). The image corresponding to the zoom-in image is an example of “first information” and a “first image” according to the present disclosure.

The fifth correct answer data is information corresponding to information on the zoom-in image (for example, information for specifying the lesion 36 and the first part that are shown in the zoom-in image). The information corresponding to the information on the zoom-in image is an example of “second information” and a “second image” according to the present disclosure.

The fifth correct answer data refers to correct answer data (that is, an annotation) for the fifth example data. Here, as an example of the fifth correct answer data, an annotation is used for specifying the geometrical characteristics of the lesion shown in the image used as the fifth example data, the type of the lesion, the subtype of the lesion, and the first part.

The recognition unit 100B acquires the zoom-in image from the controller 100A and inputs the zoom-in image acquired from the controller 100A to the fifth recognition model 110E. As a result, each time the zoom-in image is input, the fifth recognition model 110E recognizes the lesion 36 and the first part that are shown in the input zoom-in image, generates a fifth recognition result 164 that is a recognition result, and outputs the generated fifth recognition result 164. The fifth recognition result 164 is an example of an “execution result”, “related information”, and “feature region specification information” according to the present disclosure.

Meanwhile, in the sixth recognition processing 162, based on an image (hereinafter referred to as “zoom-out image”) obtained as the optical image 29A by imaging the inside of the upper gastrointestinal tract 28 via the camera 60 in a zoom-out state, the geometrical characteristics of the lesion 36 shown in the zoom-out image, the type of the lesion 36, the subtype of the lesion 36, and the like are recognized. Further, in the sixth recognition processing 162, the first part is recognized based on the zoom-out image.

Each time the zoom-out image is acquired by the recognition unit 100B, the sixth recognition processing 162 is executed on the acquired zoom-out image. The sixth recognition processing 162 is processing of recognizing the lesion 36 and the first part via a method using AI. Here, processing using a sixth recognition model 110F is executed as the sixth recognition processing 162.

The sixth recognition model 110F is a trained model for object recognition via a bounding box method using AI. The sixth recognition model 110F has been optimized by training a neural network through machine learning using sixth training data that is a data set including a plurality of data (that is, data for a plurality of frames) in which sixth example data and sixth correct answer data are associated with each other. That is, the sixth recognition model 110F is a trained model that has been optimized to receive input of the sixth example data to generate the sixth correct answer data.

The sixth example data is an image corresponding to the zoom-out image (in other words, an image assuming the zoom-out image). The image corresponding to the zoom-out image is an example of “first information” and a “first image” according to the present disclosure. The sixth correct answer data is information corresponding to information on the zoom-out image (for example, information for specifying the lesion 36 and the first part that are shown in the zoom-out image). The information corresponding to the information on the zoom-out image is an example of “second information” and a “second image” according to the present disclosure.

The sixth correct answer data refers to correct answer data (that is, an annotation) for the sixth example data. Here, as an example of the sixth correct answer data, an annotation is used for specifying the geometrical characteristics of the lesion shown in the image used as the sixth example data, the type of the lesion, the subtype of the lesion, and the first part.

The recognition unit 100B acquires the zoom-out image from the controller 100A and inputs the zoom-out image acquired from the controller 100A to the sixth recognition model 110F. As a result, each time the zoom-out image is input, the sixth recognition model 110F recognizes the lesion 36 and the first part that are shown in the input zoom-out image, generates a sixth recognition result 166 that is a recognition result, and outputs the generated sixth recognition result 166. The sixth recognition result 166 is an example of an “execution result”, “related information”, and “feature region specification information” according to the present disclosure.

The controller 100A switches the processing content in the recognition unit 100B in accordance with the variable magnification specification information 114C. That is, the controller 100A selectively executes the fifth recognition processing 160 and the sixth recognition processing 162 in accordance with the variable magnification specification information 114C.

In a case in which it is specified that the variable magnification currently being used in the camera 60 is zoom-in by referring to the variable magnification specification information 114C, the controller 100A outputs the zoom-in image to the recognition unit 100B and causes the recognition unit 100B to execute the fifth recognition processing 160. That is, the recognition unit 100B inputs the zoom-in image to the fifth recognition model 110E.

In a case in which it is specified that the variable magnification currently being used in the camera 60 is zoom-out by referring to the variable magnification specification information 114C, the controller 100A outputs the zoom-out image to the recognition unit 100B and causes the recognition unit 100B to execute the sixth recognition processing 162. That is, the recognition unit 100B inputs the zoom-out image to the sixth recognition model 110F.

As described above, in the server 2, the fifth recognition model 110E and the sixth recognition model 110F are present, and the trained model as the input destination for the optical image 29A is switched in accordance with the variable magnification specification information 114C in the processing of the recognition unit 100B. That is, the controller 100A causes the recognition unit 100B to selectively use the fifth recognition model 110E and the sixth recognition model 110F in accordance with the variable magnification specification information 114C.

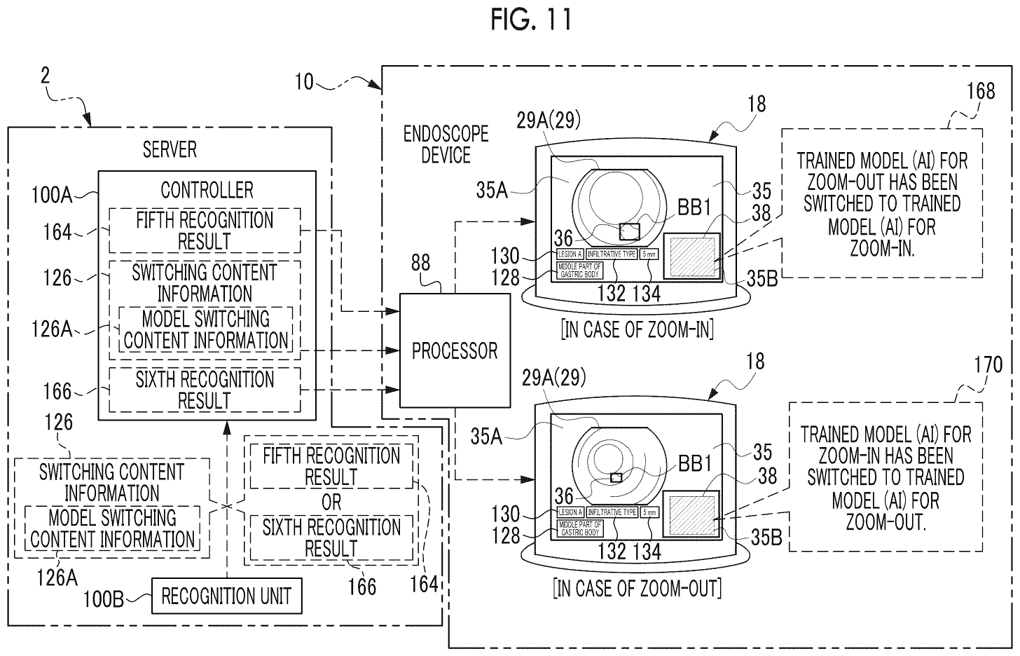

As an example, as shown in FIG. 11, in a case in which the fifth recognition processing 160 is executed by the recognition unit 100B, the recognition unit 100B outputs the fifth recognition result 164 to the controller 100A. In addition, in a case in which the sixth recognition processing 162 is executed by the recognition unit 100B, the recognition unit 100B outputs the sixth recognition result 166 to the controller 100A. Further, in a case in which the fifth recognition processing 160 is switched to the sixth recognition processing 162 by the recognition unit 100B, or in a case in which the sixth recognition processing 162 is switched to the fifth recognition processing 160 by the recognition unit 100B, the recognition unit 100B generates switching content information 126 and outputs the generated switching content information 126 to the controller 100A.

Examples of the switching content information 126 in a case in which the processing executed by the recognition unit 100B is switched from the sixth recognition processing 162 to the fifth recognition processing 160 include information for specifying an event in which the sixth recognition processing 162 is switched to the fifth recognition processing 160 by the recognition unit 100B. In addition, examples of the switching content information 126 in a case in which the processing executed by the recognition unit 100B is switched from the fifth recognition processing 160 to the sixth recognition processing 162 include information for specifying an event in which the processing executed by the recognition unit 100B is switched from the fifth recognition processing 160 to the sixth recognition processing 162.

Examples of the model switching content information 126A in a case in which the trained model used by the recognition unit 100B is switched from the sixth recognition model 110F to the fifth recognition model 110E include information for specifying an event in which the trained model to which the medical image 29 is input is switched from the sixth recognition model 110F (that is, a trained model for the zoom-out) to the fifth recognition model 110E (that is, a trained model for the zoom-in). In addition, examples of the model switching content information 126A in a case in which the trained model used by the recognition unit 100B is switched from the fifth recognition model 110E to the sixth recognition model 110F include information for specifying an event in which the trained model to which the medical image 29 is input is switched from the fifth recognition model 110E (that is, the trained model for the zoom-in) to the sixth recognition model 110F (that is, the trained model for the zoom-out).

The controller 100A transmits the fifth recognition result 164, the sixth recognition result 166, and the switching content information 126, which are input from the recognition unit 100B, to the endoscope device 10 via the external I/F 98 (see FIG. 4). In the endoscope device 10, the processor 88 receives the fifth recognition result 164, the sixth recognition result 166, and the switching content information 126 via the external I/F 86.

In a case in which the fifth recognition result 164 is received by the processor 88 via the external I/F 86, the processor 88 generates the first part name information 128, the first lesion identification information 130, the first discrimination information 132, and the first size information 134 as information based on the fifth recognition result 164, and displays the first part name information 128, the first lesion identification information 130, the first discrimination information 132, and the first size information 134 in the first display region 35A.

In a case in which the zoom-in image is displayed in the first display region 35A (that is, in a case in which the zoom-in image used for the fifth recognition processing 160 is displayed in the first display region 35A), the processor 88 displays a bounding box BB1 generated in accordance with the geometrical characteristics of the lesion 36 recognized by executing the fifth recognition processing 160, in a superimposed state on the zoom-in image displayed in the first display region 35A (for example, the zoom-in image used for the fifth recognition processing 160). In the example shown in FIG. 11, the bounding box BB1 is displayed in a superimposed state at a position at which the lesion 36 is shown in the zoom-in image displayed in the first display region 35A. The display of the bounding box BB1 is updated in synchronization with a display timing of the zoom-in image newly displayed in the first display region 35A (that is, a timing at which the zoom-in image displayed in the first display region 35A is updated).

In a case in which the trained model used by the recognition unit 100B is switched from the sixth recognition model 110F to the fifth recognition model 110E, the processor 88 converts the model switching content information 126A included in the switching content information 126 into text and displays the converted text in the second display region 35B. A message 168 is displayed in the second display region 35B as one of the pieces of auxiliary information 38. The message 168 is a message indicating an event in which the trained model for the zoom-out is switched to the trained model for the zoom-in.

In a case in which the sixth recognition result 166 is received by the processor 88 via the external I/F 86, the processor 88 generates the first part name information 128, the first lesion identification information 130, the first discrimination information 132, and the first size information 134 as information based on the sixth recognition result 166, and displays the first part name information 128, the first lesion identification information 130, the first discrimination information 132, and the first size information 134 in the first display region 35A.

In a case in which the zoom-out image is displayed in the first display region 35A (that is, in a case in which the zoom-out image used for the sixth recognition processing 162 is displayed in the first display region 35A), the processor 88 displays a bounding box BB1 generated in accordance with the geometrical characteristics of the lesion 36 recognized by executing the sixth recognition processing 162, in a superimposed state on the zoom-out image displayed in the first display region 35A (for example, the zoom-out image used for the sixth recognition processing 162). In the example shown in FIG. 11, the bounding box BB1 is displayed in a superimposed state at a position at which the lesion 36 is shown in the zoom-out image displayed in the first display region 35A. The display of the bounding box BB1 is updated in synchronization with a display timing of the zoom-out image newly displayed in the first display region 35A (that is, a timing at which the zoom-out image displayed in the first display region 35A is updated).

In a case in which the trained model used by the recognition unit 100B is switched from the fifth recognition model 110E to the sixth recognition model 110F, the processor 88 converts the model switching content information 126A included in the switching content information 126 into text and displays the converted text in the second display region 35B. A message 170 is displayed in the second display region 35B as one of the pieces of auxiliary information 38. The message 170 is a message indicating an event in which the trained model for the zoom-in is switched to the trained model for the zoom-out.

It should be noted that, in the example shown in FIG. 11, the messages 168 and 170 are shown as examples, but the same modification examples as the modification examples of the messages 136 and 146 described in the above-described embodiment can be applied to the messages 168 and 170.

As described above, according to the examples shown in FIGS. 10 and 11, the modality-related information 114 includes the variable magnification specification information 114C, and the trained model as the input destination for the optical image 29A is switched in accordance with the variable magnification specification information 114C in the processing of the recognition unit 100B. The content of the switching of the trained model is displayed on the screen 35 as the message 168 or 170. Therefore, the doctor 12 can understand, from the message 168 or 170 displayed on the screen 35, the switching content in a case in which the processing content in the recognition unit 100B is switched in accordance with the variable magnification.

In the examples shown in FIGS. 10 and 11, although the two-stage variable magnification of the zoom-in and the zoom-out is described as an example, this is merely an example, and even in a case in which variable magnification of three or more stages is executed, a trained model corresponding to each stage of the variable magnification need only be prepared, a plurality of types of trained models need only be switched in accordance with the variable magnification specification information 114C, and information indicating the switching content need only be displayed on the screen 35. In addition, although the variable magnification specification information 114C is described as an example, information for specifying a degree of magnification (for example, a magnification ratio) of the medical image 29 may be used instead of the variable magnification specification information 114C, or information indicating whether or not the medical image 29 is magnified may be used.

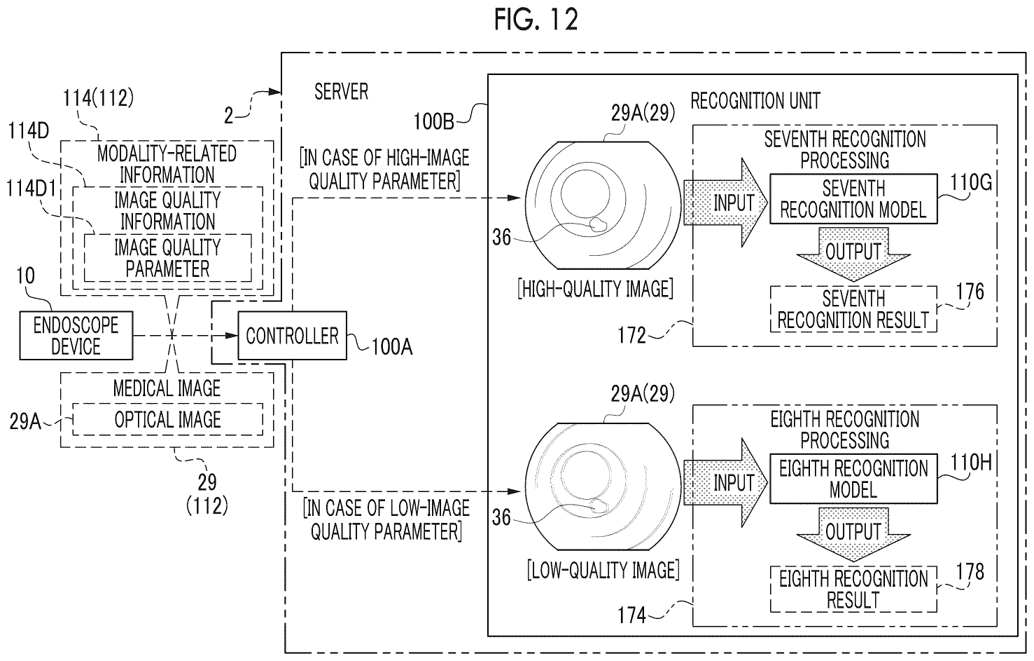

In the examples shown in FIGS. 10 and 11, the form example is described in which the modality-related information 114 includes the variable magnification specification information 114C, and the fifth recognition model 110E and the sixth recognition model 110F are switched in accordance with the variable magnification specification information 114C, but this is merely an example. For example, as shown in FIG. 12, the modality-related information 114 may include image quality information 114D, and the processing content of the recognition unit 100B may be switched in accordance with the image quality information 114D. For example, in the example shown in FIG. 12, the recognition unit 100B selectively executes seventh recognition processing 172 and eighth recognition processing 174 in accordance with the image quality information 114D.

The image quality information 114D is information (for example, information for specifying whether or not an image quality is equal to or higher than a certain level) related to an image quality of the medical image 29 (here, as an example, the optical image 29A). An image quality parameter 114D1 is included in the image quality information 114D. The image quality parameter 114D1 is a parameter for defining the image quality of the medical image 29 (here, as an example, the optical image 29A). Examples of the image quality parameter 114D1 include one or more parameters such as a gain, a dynamic range, and/or a spatial frequency.

The image quality information 114D is held by the computer (not shown) of the endoscope body 16. A content of the image quality information 114D is changed as the image quality parameter 114D1 is changed from one of a high-image quality parameter or a low-image quality parameter to the other thereof. Each of the high-image quality parameter and the low-image quality parameter is one or more parameters. The high-image quality parameter is one or more parameters capable of realizing a higher image quality of the medical image 29 than the low-image quality parameter. It should be noted that, here, for convenience of description, two parameters, the high-image quality parameter and the low-image quality parameter, are described as examples, but this is merely an example, and three or more parameters for defining different image qualities may be used.

The processor 72 of the control device 22 acquires the image quality information 114D from the endoscope body 16 at a timing at which the content of the image quality information 114D is changed. The processor 72 transmits the image quality information 114D acquired from the endoscope body 16 to the server 2 via the function expansion device 24.

In the server 2, the controller 100A outputs the optical image 29A to the recognition unit 100B. The recognition unit 100B recognizes the feature region (for example, a lesion or an organ) in the optical image 29A based on the optical image 29A input from the controller 100A. In order to realize this, the recognition unit 100B executes the seventh recognition processing 172 and the eighth recognition processing 174. The seventh recognition processing 172 and the eighth recognition processing 174 are examples of “first processing” and “AI processing” according to the present disclosure.

In the seventh recognition processing 172, based on an image that is obtained as the optical image 29A by imaging the inside of the upper gastrointestinal tract 28 and that is increased in image quality to be equal to or higher than a certain level by using the high-image quality parameter (hereinafter referred to as “high-quality image”), the geometrical characteristics of the lesion 36 shown in the high-quality image, the type of the lesion 36, the subtype of the lesion 36, and the like are recognized. Further, in the seventh recognition processing 172, the first part is recognized based on the high-quality image.

Each time the high-quality image is acquired by the recognition unit 100B, the seventh recognition processing 172 is executed on the acquired high-quality image. The seventh recognition processing 172 is processing of recognizing the lesion 36 and the first part via a method using AI. Here processing using a seventh recognition model 110G is executed as the seventh recognition processing 172.

The seventh recognition model 110G is a trained model for object recognition via a bounding box method using AI. The seventh recognition model 110G has been optimized by training a neural network through machine learning using seventh training data that is a data set including a plurality of data (that is, data for a plurality of frames) in which seventh example data and seventh correct answer data are associated with each other. That is, the seventh recognition model 110G is a trained model that has been optimized to receive input of the seventh example data to generate the seventh correct answer data.

The seventh example data is an image corresponding to the high-quality image (in other words, an image assuming the high-quality image). The image corresponding to the high-quality image is an example of “first information” and a “first image” according to the present disclosure.

The seventh correct answer data is information corresponding to information on the high-quality image (for example, information for specifying the lesion 36 and the first part that are shown in the high-quality image). The information corresponding to the information on the high-quality image is an example of “second information” and a “second image” according to the present disclosure.

The seventh correct answer data refers to correct answer data (that is, an annotation) for the seventh example data. Here, as an example of the seventh correct answer data, an annotation is used for specifying the geometrical characteristics of the lesion shown in the image used as the seventh example data, the type of the lesion, the subtype of the lesion, and the first part.

The recognition unit 100B acquires the high-quality image from the controller 100A and inputs the high-quality image acquired from the controller 100A to the seventh recognition model 110G. As a result, each time the high-quality image is input, the seventh recognition model 110G recognizes the lesion 36 and the first part that are shown in the input high-quality image, generates a seventh recognition result 176 that is a recognition result, and outputs the generated seventh recognition result 176. The seventh recognition result 176 is an example of an “execution result”, “related information”, and “feature region specification information” according to the present disclosure.

Meanwhile, in the eighth recognition processing 174, based on an image that is obtained as the optical image 29A by imaging the inside of the upper gastrointestinal tract 28 and that is increased in image quality to be lower than a certain level by using the low-image quality parameter (hereinafter referred to as “low-quality image”), the geometrical characteristics of the lesion 36 shown in the low-quality image, the type of the lesion 36, the subtype of the lesion 36, and the like are recognized. Further, in the eighth recognition processing 174, the first part is recognized based on the low-quality image.

Each time the low-quality image is acquired by the recognition unit 100B, the eighth recognition processing 174 is executed on the acquired low-quality image. The eighth recognition processing 174 is processing of recognizing the lesion 36 and the first part via a method using AI. Here, processing using an eighth recognition model 110H is executed as the eighth recognition processing 174.

The eighth recognition model 110H is a trained model for object recognition via a bounding box method using AI. The eighth recognition model 110H has been optimized by training a neural network through machine learning using eighth training data that is a data set including a plurality of data (that is, data for a plurality of frames) in which eighth example data and eighth correct answer data are associated with each other. That is, the eighth recognition model 110H is a trained model that has been optimized to receive input of the eighth example data to generate the eighth correct answer data.

The eighth example data is an image corresponding to the low-quality image (in other words, an image assuming the low-quality image). The image corresponding to the low-quality image is an example of “first information” and a “first image” according to the present disclosure.

The eighth correct answer data is information corresponding to information on the low-quality image (for example, information for specifying the lesion 36 and the first part that are shown in the low-quality image). The information corresponding to the information on the low-quality image is an example of “second information” and a “second image” according to the present disclosure.

The eighth correct answer data refers to correct answer data (that is, an annotation) for the eighth example data. Here, as an example of the eighth correct answer data, an annotation is used for specifying the geometrical characteristics of the lesion shown in the image used as the eighth example data, the type of the lesion, the subtype of the lesion, and the first part.

The recognition unit 100B acquires the low-quality image from the controller 100A and inputs the low-quality image acquired from the controller 100A to the eighth recognition model 110H. As a result, each time the low-quality image is input, the eighth recognition model 110H recognizes the lesion 36 and the first part that are shown in the input low-quality image, generates an eighth recognition result 178 that is a recognition result, and outputs the generated eighth recognition result 178. The eighth recognition result 178 is an example of an “execution result”, “related information”, and “feature region specification information” according to the present disclosure.

The controller 100A switches the processing content in the recognition unit 100B in accordance with the image quality information 114D. That is, the controller 100A selectively executes the seventh recognition processing 172 and the eighth recognition processing 174 in accordance with the image quality information 114D.

In a case in which it is specified that the image quality of the optical image 29A is equal to or higher than a certain level by referring to the image quality information 114D (that is, in a case in which it is specified that the image quality parameter 114D1 included in the image quality information 114D is the high-image quality parameter), the controller 100A outputs the optical image 29A to the recognition unit 100B as the high-quality image, and causes the recognition unit 100B to execute the seventh recognition processing 172. That is, the recognition unit 100B inputs the high-quality image to the seventh recognition model 110G.

In a case in which it is specified that the image quality of the optical image 29A is lower than a certain level by referring to the image quality information 114D (that is, in a case in which it is specified that the image quality parameter 114D1 included in the image quality information 114D is the low-image quality parameter), the controller 100A outputs the optical image 29A to the recognition unit 100B as the low-quality image, and causes the recognition unit 100B to execute the eighth recognition processing 174. That is, the recognition unit 100B inputs the low-quality image to the eighth recognition model 110H.

As described above, in the server 2, the seventh recognition model 110G and the eighth recognition model 110H are present, and the trained model as the input destination for the optical image 29A is switched in accordance with the image quality information 114D in the processing of the recognition unit 100B. That is, the controller 100A causes the recognition unit 100B to selectively use the seventh recognition model 110G and the eighth recognition model 110H in accordance with the image quality information 114D.

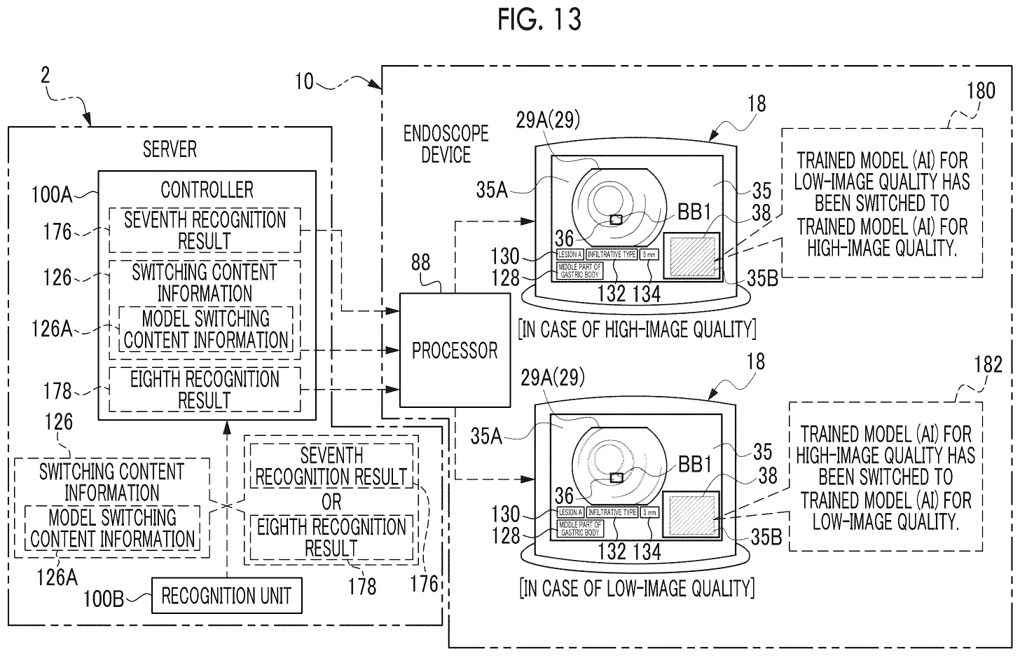

As an example, as shown in FIG. 13, in a case in which the seventh recognition processing 172 is executed by the recognition unit 100B, the recognition unit 100B outputs the seventh recognition result 176 to the controller 100A. In addition, in a case in which the eighth recognition processing 174 is executed by the recognition unit 100B, the recognition unit 100B outputs the eighth recognition result 178 to the controller 100A. Further, in a case in which the seventh recognition processing 172 is switched to the eighth recognition processing 174 by the recognition unit 100B, or in a case in which the eighth recognition processing 174 is switched to the seventh recognition processing 172 by the recognition unit 100B, the recognition unit 100B generates switching content information 126 and outputs the generated switching content information 126 to the controller 100A.

Examples of the switching content information 126 in a case in which the processing executed by the recognition unit 100B is switched from the eighth recognition processing 174 to the seventh recognition processing 172 include information for specifying an event in which the eighth recognition processing 174 is switched to the seventh recognition processing 172 by the recognition unit 100B. In addition, examples of the switching content information 126 in a case in which the processing executed by the recognition unit 100B is switched from the seventh recognition processing 172 to the eighth recognition processing 174 include information for specifying an event in which the processing executed by the recognition unit 100B is switched from the seventh recognition processing 172 to the eighth recognition processing 174.

Examples of the model switching content information 126A in a case in which the trained model used by the recognition unit 100B is switched from the eighth recognition model 110H to the seventh recognition model 110G include information for specifying an event in which the trained model to which the medical image 29 is input is switched from the eighth recognition model 110H (that is, a trained model for the low-image quality) to the seventh recognition model 110G (that is, a trained model for the high-image quality). In addition, examples of the model switching content information 126A in a case in which the trained model used by the recognition unit 100B is switched from the seventh recognition model 110G to the eighth recognition model 110H include information for specifying an event in which the trained model to which the medical image 29 is input is switched from the seventh recognition model 110G (that is, a trained model for the high-image quality) to the eighth recognition model 110H (that is, a trained model for the low-image quality).

The controller 100A transmits the seventh recognition result 176, the eighth recognition result 178, and the switching content information 126, which are input from the recognition unit 100B, to the endoscope device 10 via the external I/F 98 (see FIG. 4). In the endoscope device 10, the processor 88 receives the seventh recognition result 176, the eighth recognition result 178, and the switching content information 126 via the external I/F 86.

In a case in which the seventh recognition result 176 is received by the processor 88 via the external I/F 86, the processor 88 generates the first part name information 128, the first lesion identification information 130, the first discrimination information 132, and the first size information 134 as information based on the seventh recognition result 176, and displays the first part name information 128, the first lesion identification information 130, the first discrimination information 132, and the first size information 134 in the first display region 35A.

In a case in which the high-quality image is displayed in the first display region 35A (that is, in a case in which the high-quality image used for the seventh recognition processing 172 is displayed in the first display region 35A), the processor 88 displays a bounding box BB1 generated in accordance with the geometrical characteristics of the lesion 36 recognized by executing the seventh recognition processing 172, in a superimposed state on the high-quality image displayed in the first display region 35A (for example, the high-quality image used for the seventh recognition processing 172). In the example shown in FIG. 13, the bounding box BB1 is displayed in a superimposed state at a position at which the lesion 36 is shown in the high-quality image displayed in the first display region 35A. The display of the bounding box BB1 is updated in synchronization with a display timing of the high-quality image newly displayed in the first display region 35A (that is, a timing at which the high-quality image displayed in the first display region 35A is updated).

In a case in which the trained model used by the recognition unit 100B is switched from the eighth recognition model 110H to the seventh recognition model 110G, the processor 88 converts the model switching content information 126A included in the switching content information 126 into text and displays the converted text in the second display region 35B. A message 180 is displayed in the second display region 35B as one of the pieces of auxiliary information 38. The message 180 is a message indicating an event in which the trained model for the low-image quality is switched to the trained model for the high-image quality.

In a case in which the eighth recognition result 178 is received by the processor 88 via the external I/F 86, the processor 88 generates the first part name information 128, the first lesion identification information 130, the first discrimination information 132, and the first size information 134 as information based on the eighth recognition result 178, and displays the first part name information 128, the first lesion identification information 130, the first discrimination information 132, and the first size information 134 in the first display region 35A.

In a case in which the low-quality image is displayed in the first display region 35A (that is, in a case in which the low-quality image used for the eighth recognition processing 174 is displayed in the first display region 35A), the processor 88 displays a bounding box BB1 generated in accordance with the geometrical characteristics of the lesion 36 recognized by executing the eighth recognition processing 174, in a superimposed state on the low-quality image displayed in the first display region 35A (for example, the low-quality image used for the eighth recognition processing 174). In the example shown in FIG. 13, the bounding box BB1 is displayed in a superimposed state at a position at which the lesion 36 is shown in the low-quality image displayed in the first display region 35A. The display of the bounding box BB1 is updated in synchronization with a display timing of the low-quality image newly displayed in the first display region 35A (that is, a timing at which the low-quality image displayed in the first display region 35A is updated).

In a case in which the trained model used by the recognition unit 100B is switched from the seventh recognition model 110G to the eighth recognition model 110H, the processor 88 converts the model switching content information 126A included in the switching content information 126 into text and displays the converted text in the second display region 35B. A message 182 is displayed in the second display region 35B as one of the pieces of auxiliary information 38. The message 182 is a message indicating an event in which the trained model for the high-image quality is switched to the trained model for the low-image quality.

It should be noted that, in the example shown in FIG. 13, the messages 180 and 182 are shown as examples, but the same modification examples as the modification examples of the messages 136 and 146 described in the above-described embodiment can be applied to the messages 180 and 182.

As described above, according to the examples shown in FIGS. 12 and 13, the modality-related information 114 includes the image quality information 114D, and the trained model as the input destination for the optical image 29A is switched in accordance with the image quality information 114D in the processing of the recognition unit 100B. The content of the switching of the trained model is displayed on the screen 35 as the message 180 or 182. Therefore, the doctor 12 can understand, from the message 180 or 182 displayed on the screen 35, the switching content in a case in which the processing content in the recognition unit 100B is switched in accordance with the image quality of the optical image 29A.

In the examples shown in FIGS. 12 and 13, although the high-quality image and the low-quality image are described as examples, this is merely an example, and even in a case in which three or more medical images 29 having different image qualities are obtained, the trained model corresponding to each image quality need only be prepared, and a plurality of types of trained models need only be switched in accordance with the image quality information 114D.

In the example shown in FIG. 12, the form example is described in which the recognition unit 100B selectively executes the seventh recognition processing 172 and the eighth recognition processing 174 in accordance with the image quality information 114D, but this is merely an example. For example, the recognition unit 100B may execute only the seventh recognition processing 172, and only the high-quality image may be input to the seventh recognition model 110G. Here, the reason why the low-quality image is not input to the seventh recognition model 110G is that there is a risk that the accuracy of the seventh recognition result 176, which is obtained by inputting the low-quality image to the seventh recognition model 110G as the trained model for the high-quality image, is decreased to be lower than a reference level.

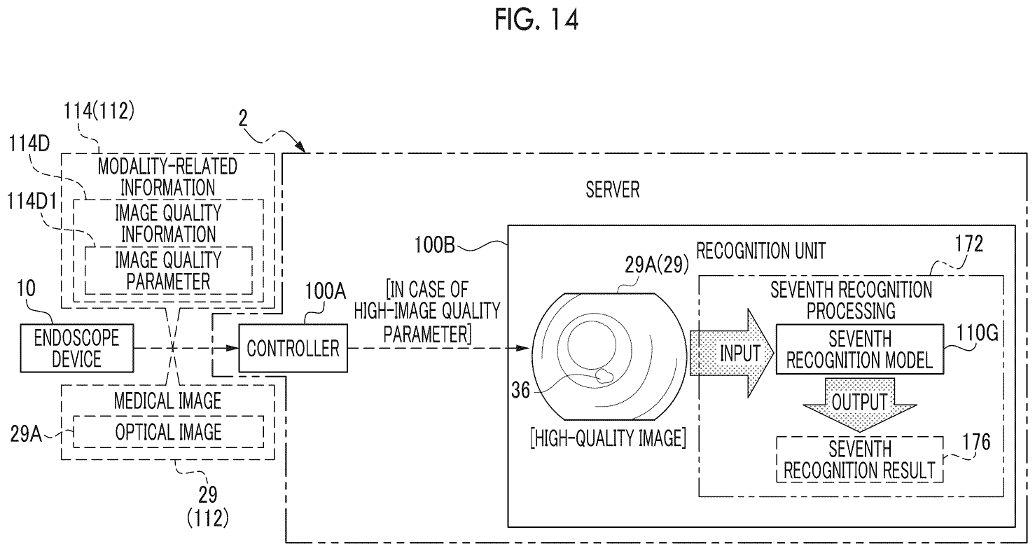

FIG. 14 is a conceptual diagram showing an example of an aspect in which the high-quality image is input to the seventh recognition model 110G. As shown in FIG. 14, in a case in which it is specified that the image quality of the optical image 29A is equal to or higher than a certain level by referring to the image quality information 114D (that is, in a case in which it is specified that the image quality parameter 114D1 included in the image quality information 114D is the high-image quality parameter), the controller 100A outputs the optical image 29A to the recognition unit 100B as the high-quality image, operates the seventh recognition model 110G, and causes the recognition unit 100B to execute the seventh recognition processing 172. On the other hand, in a case in which it is specified that the image quality of the optical image 29A is lower than a certain level by referring to the image quality information 114D (that is, in a case in which it is specified that the image quality parameter 114D1 included in the image quality information 114D is the low-image quality parameter), the controller 100A does not output the optical image 29A to the recognition unit 100B, does not operate the seventh recognition model 110G, and does not cause the recognition unit 100B to execute the seventh recognition processing 172.

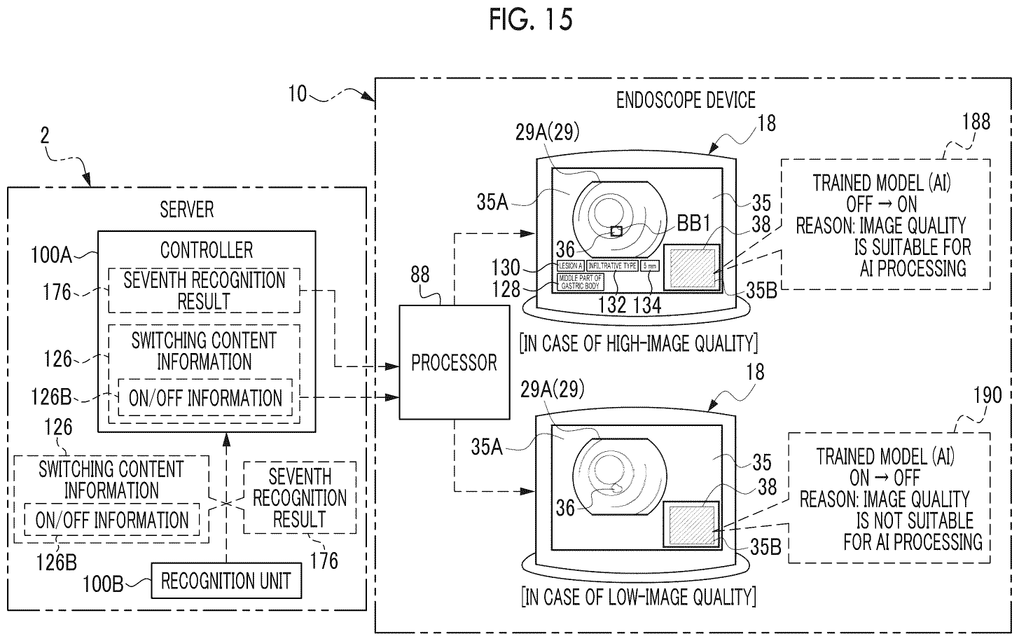

In this case, as shown in FIG. 15 as an example, the switching content information 126 includes on/off information 126B. The on/off information 126B is information indicating that the seventh recognition model 110G is switched from on to off (that is, the seventh recognition model 110G is switched from an operating state to a non-operating state) or that the seventh recognition model 110G is switched from off to on (that is, the seventh recognition model 110G is switched from a non-operating state to an operating state).

The controller 100A transmits the seventh recognition result 176 and the switching content information 126, which are input from the recognition unit 100B, to the endoscope device 10 via the external I/F 98 (see FIG. 4). In the endoscope device 10, the processor 88 receives the seventh recognition result 176 and the switching content information 126 via the external I/F 86. The processor 88 executes processing using the seventh recognition result 176, in the same manner as in the example shown in FIG. 13.

In a case in which the on/off information 126B included in the switching content information 126 received by the processor 88 indicates that the seventh recognition model 110G is switched from off to on, the processor 88 displays a message 188 as one of the pieces of auxiliary information 38 in the second display region 35B. The message 188 is a message indicating the switching of the trained model used by the recognition unit 100B from off to on and the reason why the trained model is switched from off to on.

On the other hand, in a case in which the on/off information 126B included in the switching content information 126 received by the processor 88 indicates that the seventh recognition model 110G is switched from on to off, the processor 88 displays a message 190 as one of the pieces of auxiliary information 38 in the second display region 35B. The message 190 is a message indicating the switching of the trained model used by the recognition unit 100B from on to off and the reason why the trained model is switched from on to off.

As described above, according to the examples shown in FIGS. 14 and 15, the messages 188 and 190 are selectively displayed in the second display region 35B in accordance with the on/off information 126B included in the switching content information 126. Therefore, the doctor 12 can understand, from the message 188 or 190, whether the trained model used by the recognition unit 100B is switched from on to off or switched from off to on. In addition, the doctor 12 can understand, from the message 188 or 190, the reason why the trained model used by the recognition unit 100B is switched from on to off or the reason why the trained model is switched from off to on.

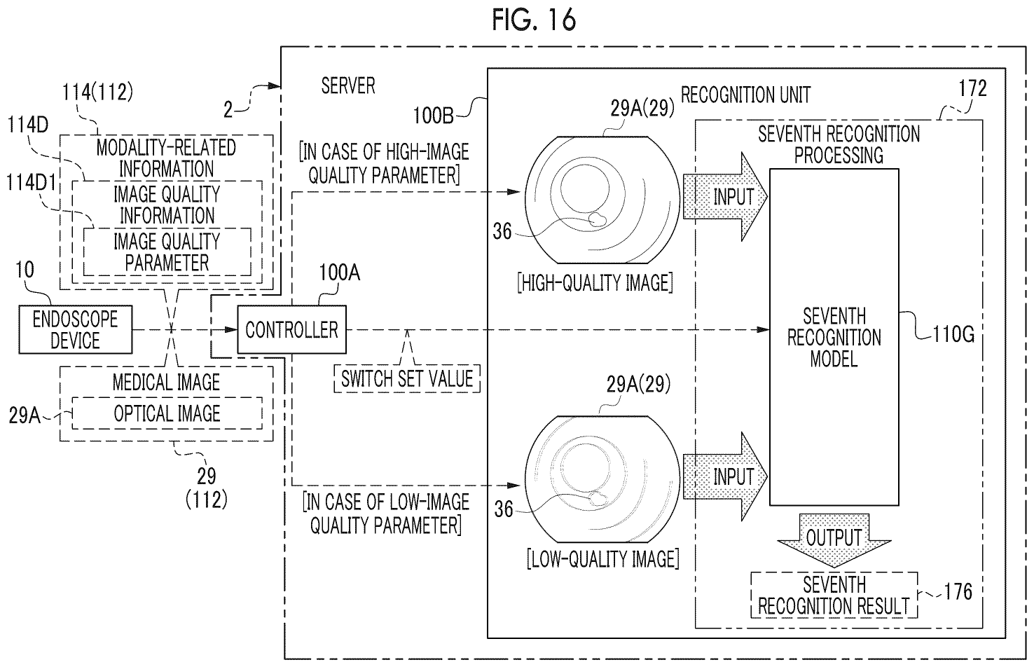

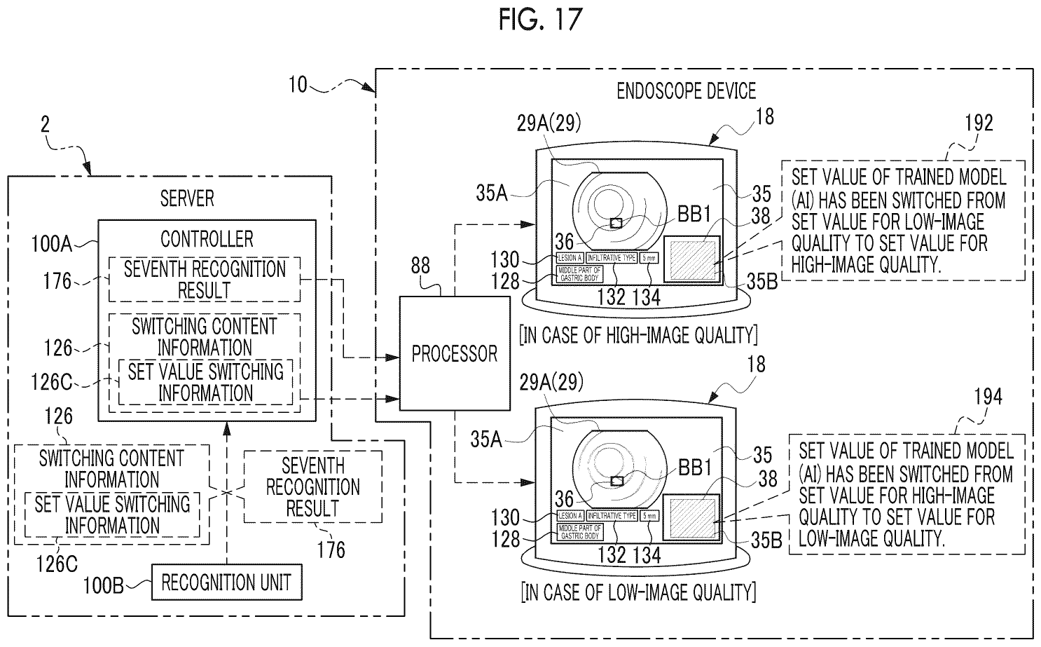

In the example shown in FIG. 14, although the form example is described in which the high-quality image is input to the seventh recognition model 110G and the low-quality image is not input to the seventh recognition model 110G, this is merely an example, and, for example, as shown in FIG. 16, the low-quality image may also be input to the seventh recognition model 110G. However, in a case in which the low-quality image is input to the seventh recognition model 110G (that is, the trained model for the high-quality image), there is a risk that the accuracy of the seventh recognition result 176 is decreased to be lower than the reference level. Therefore, the controller 100A switches a set value of the seventh recognition model 110G (for example, a threshold value for determining a score of an output layer) such that the accuracy of the seventh recognition result 176 is equal to or higher than the reference level in both a case in which the high-quality image is input to the seventh recognition model 110G and a case in which the low-quality image is input to the seventh recognition model 110G. In this case, as shown in FIG. 17 as an example, set value switching information 126C is included in the switching content information 126. The set value switching information 126C is information indicating that a set value (hereinafter referred to as “set value for the high-image quality”) applied to the seventh recognition model 110G in a case in which the high-quality image is input to the seventh recognition model 110G is switched to a set value (hereinafter referred to as “set value for the low-image quality”) applied to the seventh recognition model 110G in a case in which the low-quality image is input to the seventh recognition model 110G, or indicating that the set value for the low-image quality is switched to the set value for the high-image quality.

In a case in which it is indicated that the set value is switched from the set value for the low-image quality to the set value for the high-image quality by the set value switching information 126C included in the switching content information 126 received by the processor 88, the processor 88 displays a message 192 as one of the pieces of auxiliary information 38 in the second display region 35B. The message 192 is a message indicating that the set value of the trained model is switched from the set value for the low-image quality to the set value for the high-image quality.

On the other hand, in a case in which it is indicated that the set value is switched from the set value for the high-image quality to the set value for the low-image quality by the set value switching information 126C included in the switching content information 126 received by the processor 88, the processor 88 displays a message 194 as one of the pieces of auxiliary information 38 in the second display region 35B. The message 194 is a message indicating that the set value of the trained model is switched from the set value for the high-image quality to the set value for the low-image quality.

As described above, according to the examples shown in FIGS. 16 and 17, the messages 192 and 194 are selectively displayed in the second display region 35B in accordance with the set value switching information 126C included in the switching content information 126. Therefore, the doctor 12 can understand, from the message 192 or 194, whether the set value of the trained model used by the recognition unit 100B is switched from the set value for the low-image quality to the set value for the high-image quality or switched from the set value for the high-image quality to the set value for the low-image quality.

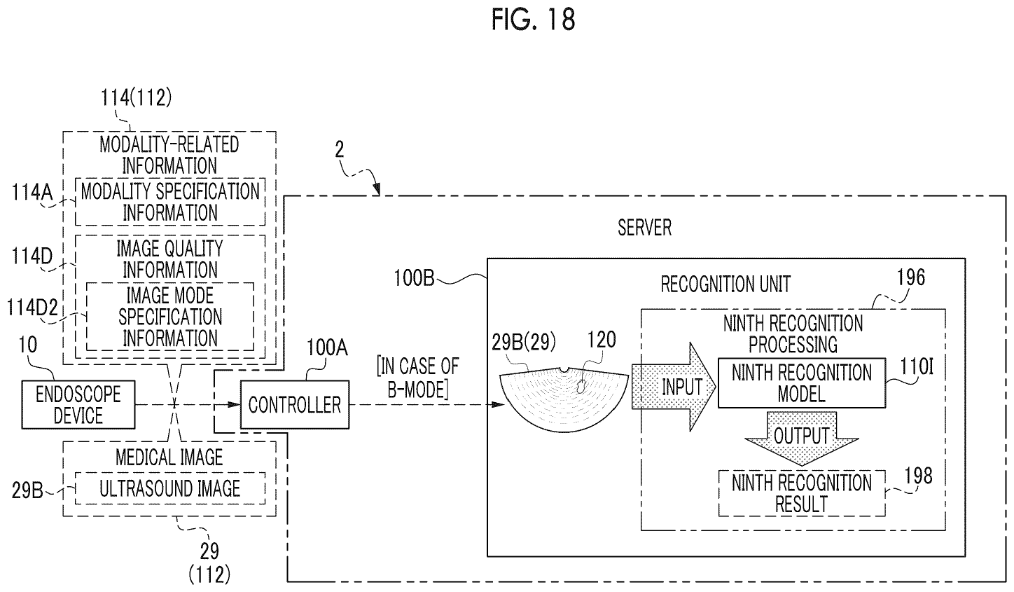

In the example shown in FIG. 14, the form example is described in which the high-quality image is input to the seventh recognition model 110G, but this is merely an example, and, for example, as shown in FIG. 18, the ultrasound image 29B (hereinafter referred to as “B-mode ultrasound image 29B”) obtained in a case in which the image mode applied to the ultrasound-type upper endoscope device is a B-mode may be input to a ninth recognition model 110I. The ninth recognition model 110I is a trained model that is generated in the same manner as the second recognition model 110B. The ninth recognition model 110I is different from the second recognition model 110B in that the ninth recognition model 110I is a trained model generated assuming that the B-mode ultrasound image 29B is input.

In the example shown in FIG. 18, image mode specification information 114D2 is included in the image quality information 114D. The image mode specification information 114D2 is information for specifying an image mode applied to the ultrasound-type upper endoscope device.

In a case in which it is specified that the ultrasound image 29B is the B-mode ultrasound image 29B by referring to the image mode specification information 114D2 included in the image quality information 114D, the controller 100A outputs the ultrasound image 29B to the recognition unit 100B, operates the ninth recognition model 110I, and causes the recognition unit 100B to execute ninth recognition processing 196. On the other hand, in a case in which it is specified that the ultrasound image 29B is the ultrasound image 29B other than the B-mode (that is, the ultrasound image 29B obtained in a case in which the image mode applied to the ultrasound-type upper endoscope device is an image mode other than the B-mode) by referring to the image mode specification information 114D2 included in the image quality information 114D, the controller 100A does not output the ultrasound image 29B to the recognition unit 100B, does not operate the ninth recognition model 110I, and does not cause the recognition unit 100B to execute the ninth recognition processing 196. Examples of the ultrasound image 29B other than the B-mode include a Doppler-mode ultrasound image 29B, an elastography-mode ultrasound image 29B, a THI-mode ultrasound image 29B, a CH-mode ultrasound image 29B, and a CHI-mode ultrasound image 29B. The reason why the ultrasound image 29B other than the B-mode is not input to the ninth recognition model 110I is that there is a risk that the accuracy of a ninth recognition result 198, which is obtained by inputting the ultrasound image 29B other than the B-mode to the ninth recognition model 110I (that is, a trained model for the B-mode), is decreased to be lower than the reference level.

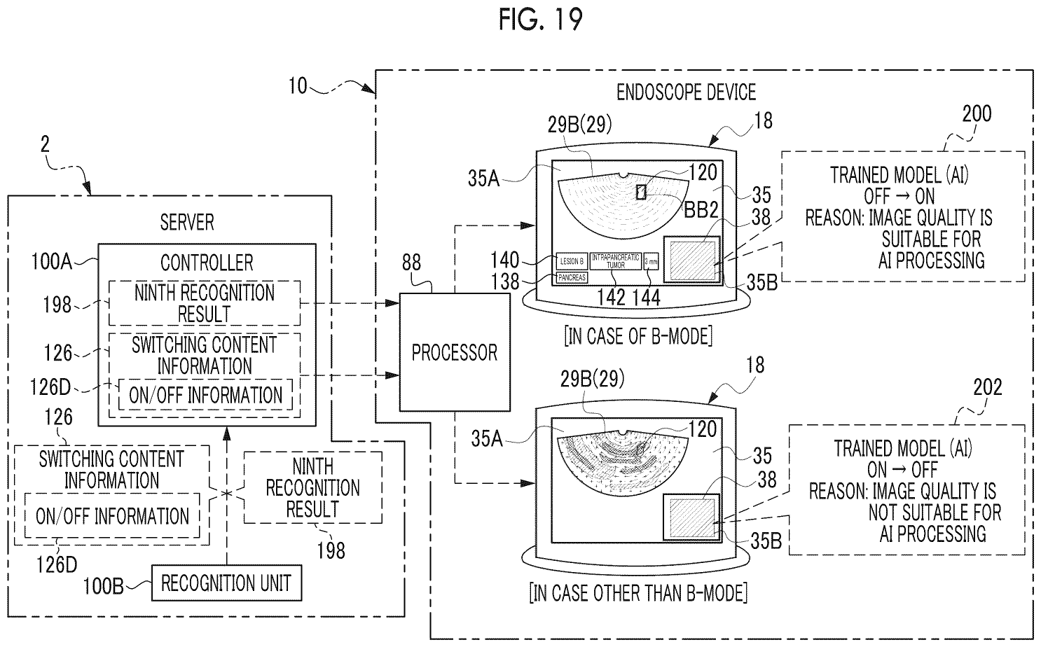

In this way, in a case in which the B-mode ultrasound image 29B is input to the ninth recognition model 110I, and the ultrasound image 29B other than the B-mode is not input to the ninth recognition model 110I, as shown in FIG. 19 as an example, the switching content information 126 includes on/off information 126D. The on/off information 126D is information indicating that the ninth recognition model 110I is switched from on to off (that is, the ninth recognition model 110I is switched from an operating state to a non-operating state) or that the ninth recognition model 110I is switched from off to on (that is, the ninth recognition model 110I is switched from a non-operating state to an operating state).

The controller 100A transmits the ninth recognition result 198 and the switching content information 126, which are input from the recognition unit 100B, to the endoscope device 10 via the external I/F 98 (see FIG. 4). In the endoscope device 10, the processor 88 receives the ninth recognition result 198 and the switching content information 126 via the external I/F 86. The processor 88 executes processing using the ninth recognition result 198, in the same manner as in the example shown in FIG. 6.

In a case in which the on/off information 126D included in the switching content information 126 received by the processor 88 indicates that the ninth recognition model 110I is switched from off to on, the processor 88 displays a message 200 as one of the pieces of auxiliary information 38 in the second display region 35B. The message 200 is a message indicating the switching of the trained model used by the recognition unit 100B from off to on and the reason why the trained model is switched from off to on.

On the other hand, in a case in which the on/off information 126D included in the switching content information 126 received by the processor 88 indicates that the ninth recognition model 110I is switched from on to off, the processor 88 displays a message 202 as one of the pieces of auxiliary information 38 in the second display region 35B. The message 202 is a message indicating the switching of the trained model used by the recognition unit 100B from on to off and the reason why the trained model is switched from on to off.

As described above, according to the examples shown in FIGS. 18 and 19, the messages 200 and 202 are selectively displayed in the second display region 35B in accordance with the on/off information 126D included in the switching content information 126. Therefore, the doctor 12 can understand, from the message 200 or 202, whether the trained model used by the recognition unit 100B is switched from on to off or switched from off to on. In addition, the doctor 12 can understand, from the message 200 or 202, the reason why the trained model used by the recognition unit 100B is switched from on to off or the reason why the trained model is switched from off to on.

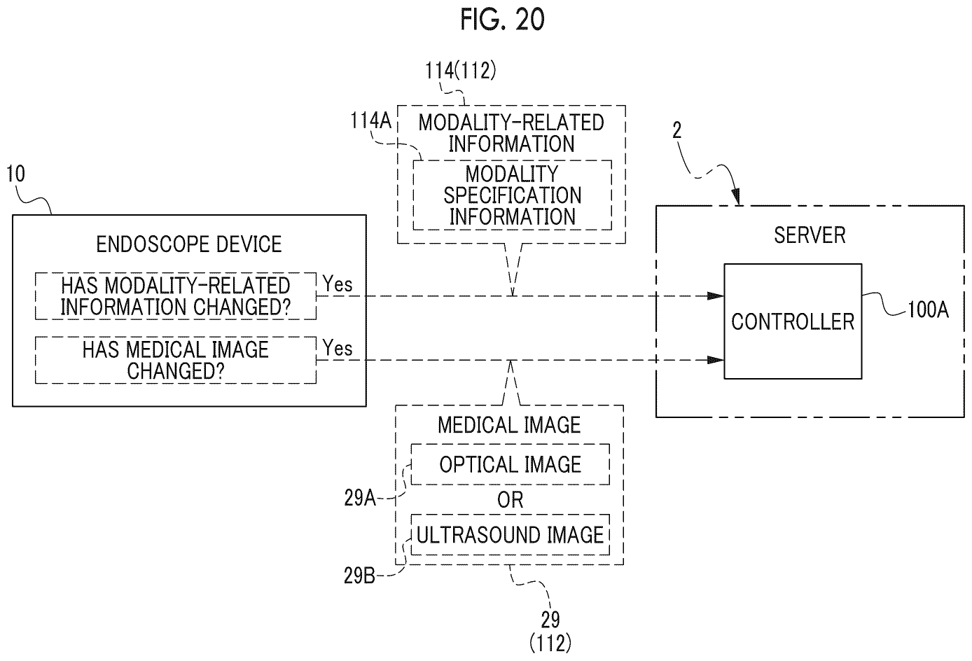

In the above-described embodiment, the form example is described in which the endoscope device 10 transmits the medical information 112 to the server 2, but the endoscope device 10 may transmit the medical information 112 to the server 2 on the condition that a change has occurred in the medical information 112. In addition, the endoscope device 10 may transmit a changed part included in the medical information 112 to the server 2 on the condition that a change has occurred in the part. For example, as shown in FIG. 20, in a case in which a change has occurred in the modality-related information 114, the endoscope device 10 may transmit the modality-related information 114 to the server 2. In addition, in a case in which a change has occurred in the modality specification information 114A, the endoscope device 10 may transmit the modality specification information 114A to the server 2. In addition, in a case in which a change has occurred in the medical image 29, the endoscope device 10 may transmit the medical image 29 in which the change has occurred to the server 2. For example, in a case in which a change has occurred in the optical image 29A, the endoscope device 10 may transmit the optical image 29A to the server 2, and in a case in which a change has occurred in the ultrasound image 29B, the endoscope device 10 may transmit the ultrasound image 29B to the server 2. In this way, it is possible to contribute to the reduction of the communication volume between the endoscope device 10 and the server 2. In addition, the processing load on the server 2 can also be reduced.

In the above-described embodiment, the form example is described in which only the AI processing (that is, the recognition processing using the trained model) is executed by the recognition unit 100B, but the AI processing and non-AI processing (for example, processing of recognizing the feature region using a template matching method) may be selectively executed by the recognition unit 100B. In this case, the AI processing and the non-AI processing need only be switched in accordance with the medical information 112 in the same manner as in the above-described embodiment, and the information indicating the switching content in a case in which the AI processing and the non-AI processing are switched need only be used as the switching content information 126.

In the above-described embodiment, the form example is described in which the recognition unit 100B executes the AI processing on the medical image 29, but this is merely an example, and the AI processing may be executed on the modality-related information 114. In this case, processing using so-called generative AI may be executed on the modality-related information 114. Examples of the generative AI include ChatGPT using GPT-4 (Internet search <https://openai.com/gpt-4>). Examples of the generative AI also include Stable Diffusion, Midjourney, and Craiyon.

For example, instruction data (so-called prompt) including at least a part of the modality-related information 114 may be input to the generative AI, and information indicating an operation method of the endoscope device 10, information for guiding a content of a medical treatment that is recommended to be performed during the endoscopy, or information for guiding a content of a medical treatment that is recommended to be performed after the endoscopy may be output from the generative AI as text information, voice information, and/or image information. The information output from the generative AI may be stored in various storage media (for example, the storage 76, 92, and/or 104), may be registered in an electronic medical record, may be displayed on the display device 18 as the auxiliary information 38, may be printed on a medium by a printer, or may be output from a speaker as voice.

In a case in which the AI processing using the generative AI is executed as described above, the AI processing using the generative AI and processing other than the AI processing using the generative AI (for example, the AI processing not using the generative AI (that is, the AI processing using the recognition unit 100B described in the above-described embodiment) and/or the non-AI processing) may be switched in accordance with the medical information 112 (for example, the medical image 29 and/or the modality-related information 114). In this case as well, the switching content information 126 need only be generated and output by the recognition unit 100B in the same manner as in the above-described embodiment.

In the above-described embodiment, the lesion 36 is described as an example of a “feature region” according to the present disclosure, but the present disclosure is not limited thereto, and the technology of the present disclosure is applicable even in a case in which a resection region, a bleeding region, a marking region, an organ, a treatment tool (for example, a hemostatic clip placed inside the body), or the like is applied instead of the lesion 36.

In the above-described embodiment, the endoscope device 10 is described as an example, but the technology of the present disclosure is not limited thereto. For example, the technology of the present disclosure can also be applied to an X-ray imaging apparatus, an external ultrasound probe, MRI, CT, or an eye fundus examination device.

In the above-described embodiment, the AI processing using the bounding box method is described as an example, but this is merely an example, and, for example, AI processing using a segmentation method may be executed instead of the AI processing using the bounding box method. In addition, instead of the AI processing, recognition processing using a non-AI method (for example, the template matching method) may be executed, or recognition processing using a combination of the non-AI method and the AI method may be executed.

In the above-described embodiment, the hybrid-type endoscope device including the optical-type upper endoscope device and the ultrasound-type upper endoscope device is described as the endoscope device 10, but the optical-type upper endoscope device and the ultrasound-type upper endoscope device may be separate bodies. In this case, for example, on the condition that the optical-type upper endoscope device is connected to the external I/F 70, the endoscope device 10 transmits the information for specifying the optical-type upper endoscope device to the server 2 as the modality specification information 114A. In addition, for example, on the condition that the ultrasound-type upper endoscope device is connected to the external I/F 70, the endoscope device 10 transmits the information for specifying the ultrasound-type upper endoscope device to the server 2 as the modality specification information 114A.

In the above-described embodiment, the form example is described in which the medical support program 108 is stored in the storage 104, but the present disclosure is not limited thereto. For example, the medical support program 108 may be stored in a portable computer-readable non-transitory storage medium such as an SSD or a USB memory. The medical support program 108 stored in the non-transitory storage medium is installed in the computer 96 of the server 2. The processor 100 executes the medical support process in accordance with the medical support program 108.

The medical support program 108 may be stored in a storage device of another computer or the like connected to the server 2 via a network, and the medical support program 108 may be downloaded in response to a request from the server 2 and installed in the computer 96.

It should be noted that it is not necessary to store the entire medical support program 108 in a storage device of another computer or the like connected to the server 2 or to store the entire medical support program 108 in the storage 104, and a part of the medical support program 108 may be stored.

Various processors described below can be used as the hardware resource for executing the medical support process. Examples of the processor include a CPU which is a general-purpose processor that functions as the hardware resource executing the medical support process by executing software, that is, a program. In addition, examples of the processor include a dedicated electric circuit which is a processor of which a circuit configuration is specially designed for executing specific processing, such as an FPGA, a PLD, or an ASIC. Any processor has a memory built in or connected to it, and any processor executes the medical support process by using the memory.

The hardware resource for executing the medical support process may be configured by one of the various processors or by combining two or more processors of the same type or different types (for example, by combining a plurality of FPGAs or by combining a CPU and an FPGA). The hardware resource for executing the medical support process may also be one processor.

As an example of the configuration using one processor, first, there is a form in which one processor is configured by combining one or more CPUs and software, and the processor functions as the hardware resource for executing the medical support process. As a second example, as typified by an SoC or the like, there is a form in which a processor that realizes all functions of a system including a plurality of hardware resources executing the medical support process with one IC chip is used. As described above, the medical support process is realized by using one or more of the various processors as the hardware resource.

As a hardware structure of these various processors, more specifically, an electric circuit in which circuit elements, such as semiconductor elements, are combined can be used. Further, the medical support process is merely an example. Therefore, it goes without saying that unnecessary steps may be deleted, new steps may be added, or the processing order may be changed within a range that does not deviate from the gist.

The above-described contents and the above-shown contents are the detailed description of the parts according to the present disclosure, and are merely examples of the present disclosure. For example, the description of the configuration, the function, the operation, and the effect is the description of examples of the configuration, the function, the operation, and the effect of the parts according to the present disclosure. Accordingly, it goes without saying that unnecessary parts may be deleted, new elements may be added, or replacements may be made with respect to the above-described contents and the above-shown contents within a range that does not deviate from the gist of the present disclosure. In addition, in order to avoid complications and facilitate understanding of the parts according to the present disclosure, the description of common technical knowledge or the like, which does not particularly require the description for enabling the implementation of the present disclosure, is omitted in the above-described contents and the above-shown contents.

All of the documents, the patent applications, and the technical standards described in the present specification are incorporated into the present specification by reference to the same extent as in a case in which the individual documents, patent applications, and technical standards are specifically and individually stated to be described by reference.

What is claimed is:

1. A medical support device comprising:
a processor,
wherein the medical support device communicates with an external device that transmits medical information including a medical image and/or modality-related information,
the medical image is obtained by imaging a subject via a modality,
the modality-related information is information on the modality at a timing at which the medical image is obtained, and
the processor
receives the medical information transmitted from the external device,
executes first processing on the medical information,
transmits an execution result obtained by executing the first processing,
switches a processing content of the first processing in accordance with the medical information, and
transmits switching content information indicating a switching content in a case in which the processing content is switched.

2. The medical support device according to claim 1,
wherein the first processing includes AI processing of generating related information related to the medical information by inputting the medical information to a trained model that receives input of first information corresponding to the medical information to generate second information corresponding to the related information.

3. The medical support device according to claim 2,
wherein the switching content information in a case in which a processing content of the AI processing is switched includes AI processing switching content information indicating a content in which the processing content of the AI processing is switched.

4. The medical support device according to claim 3,
wherein a plurality of types of the trained models are present,
the trained model as an input destination for the medical information is switched in accordance with the medical information in the AI processing, and
the AI processing switching content information in a case in which the trained model is switched includes model switching content information indicating a content in which the trained model is switched.

5. The medical support device according to claim 4,
wherein the model switching content information includes trained model specification information for specifying the trained model used to obtain the execution result transmitted by the processor.

6. The medical support device according to claim 4,
wherein the medical information includes the modality-related information, and
the trained model as the input destination for the medical information is switched in accordance with the modality-related information in the AI processing.

7. The medical support device according to claim 6,
wherein the medical information includes the medical image, and
the trained model as the input destination for the medical image is switched in accordance with the modality-related information in the AI processing.

8. The medical support device according to claim 4,
wherein the medical information includes the medical image and the modality-related information,
the modality-related information includes light source specification information for specifying a light source used for imaging to obtain the medical image, and
the trained model as the input destination for the medical image is switched in accordance with the light source specification information in the AI processing.

9. The medical support device according to claim 4,
wherein the medical information includes the medical image and the modality-related information,
the modality-related information includes variable magnification specification information for specifying variable magnification applied to the medical image, and
the trained model as the input destination for the medical image is switched in accordance with the variable magnification specification information in the AI processing.

10. The medical support device according to claim 4,
wherein the medical information includes the modality-related information,
the modality-related information includes modality specification information for specifying the modality, and
the trained model as the input destination for the medical information is switched in accordance with the modality specification information in the AI processing.

11. The medical support device according to claim 10,
wherein the medical information includes the medical image, and
the trained model as the input destination for the medical image is switched in accordance with the modality specification information in the AI processing.

12. The medical support device according to claim 2,
wherein the medical information includes the medical image and the modality-related information,
the modality-related information includes image quality information that is information on an image quality of the medical image, and
a processing content of the AI processing is switched in accordance with the image quality information.

13. The medical support device according to claim 12,
wherein the image quality information includes a parameter for defining the image quality and/or image mode specification information for specifying an image mode applied to the modality to obtain the medical image.

14. The medical support device according to claim 2,
wherein the medical information includes the medical image,
the first information is a first image corresponding to the medical image,
the second information is information for specifying a first region corresponding to a feature region shown in the medical image, and
the trained model receives input of the medical image to generate feature region specification information for specifying the feature region as the related information.

15. The medical support device according to claim 1,
wherein the modality is an endoscope device, and
the medical image is an endoscopic image obtained by imaging an inside of a body of the subject via the endoscope device.

16. A medical support system comprising:
the medical support device according to claim 1; and
the external device.

17. The medical support system according to claim 16,
wherein the external device transmits the medical information to the medical support device on a condition that a change has occurred in the medical information.

18. The medical support system according to claim 16,
wherein the external device transmits a part included in the medical information to the medical support device on a condition that a change has occurred in the part.

19. An operation method of a medical support device that communicates with an external device that transmits medical information including a medical image and/or modality-related information,
wherein the medical image is obtained by imaging a subject via a modality,
the modality-related information is information on the modality at a timing at which the medical image is obtained, and
the operation method comprises:
receiving the medical information transmitted from the external device;
executing first processing on the medical information;
transmitting an execution result obtained by executing the first processing;
switching a processing content of the first processing in accordance with the medical information; and
transmitting switching content information indicating a switching content in a case in which the processing content is switched.

20. A non-transitory computer-readable storage medium storing a program executable by a computer applied to a medical support device that communicates with an external device that transmits medical information including a medical image and/or modality-related information, to execute a medical support process,
wherein the medical image is obtained by imaging a subject via a modality,
the modality-related information is information on the modality at a timing at which the medical image is obtained, and
the medical support process comprises:
executing first processing on the medical information;
transmitting an execution result obtained by executing the first processing;
switching a processing content of the first processing in accordance with the medical information; and
transmitting switching content information indicating a switching content in a case in which the processing content is switched.
